(19) United States
(12) Patent Application Publication
(10) Pub. No.: US 2025/0271873 A1
(43) Pub. Date: Aug. 28, 2025

(54) SYSTEM AND METHOD FOR AUTONOMOUSLY NAVIGATING AN ANIMAL ENVIRONMENT AND PERFORMING TASKS

(71) Applicant: Bird's Eye Robotics, Inc., Herman, NE (US)

(72) Inventors: John Miller, Omaha, NE (US); Wendwosen Bedada, Omaha, NE (US); William Nick, Omaha, NE (US)

(21) Appl. No.: 19/207,760

(22) Filed: May 14, 2025

Related U.S. Application Data
(63) Continuation-in-part of application No. 18/751,950, filed on Jun. 24, 2024.
Application No. 18/751,950 is a continuation-in-part of application No. 17/582,835, filed on Jan. 24, 2022, now Pat. No. 12,016,310.
(60) Provisional application No. 63/141,671, filed on Jan. 26, 2021.

(51) Int. Cl. G05D 1/689; A01K 29/00; A01M 29/00; G05D 1/229; G05D 105/50

(52) U.S. Cl. CPC G05D 1/689; A01K 29/005; A01M 29/00; G05D 1/229; G05D 2105/50

(57) ABSTRACT

A navigation device provides for autonomous interactions with animals and navigation of the animal environment, such as a poultry barn. The navigation device includes one or more cameras for detecting animals. The navigation device also includes one or more cameras for object detection purposes. The navigation device also includes a camera or a LiDAR for mapping the position and orientation (pose) of the navigation device within the environment. By the object detection and the pose information, the navigation device autonomously travels within the environment. The navigation device also includes a spinner assembly for deterring animals from the path of the navigation device.

### CROSS-REFERENCE TO RELATED APPLICATIONS

This application is a Continuation-in-Part of and claims priority to U.S. patent application Ser. No. 18/751,950, filed on Jun. 24, 2024, to Scott Niewohner et al., entitled “System and Method for Dynamically Altering a Device for Moving Animals,” currently pending, which is a Continuation-in-Part of and claims priority to U.S. patent application Ser. No. 17/582,835, filed on Jan. 24, 2022, to Scott Niewohner et al., entitled “System and Method for Identifying and Recovering Expired Poultry,” now issued U.S. Pat. No. 12,016,310, which claims priority to U.S. Provisional Patent Application No. 63/141,671, filed on December Jan. 26, 2021, entitled “System and Method for Identifying and Recovering Expired Poultry.” The entire disclosures, including the specifications and drawings, of the above-referenced applications are incorporated herein by reference.

### FIELD OF THE INVENTION

The present disclosure generally relates to animal husbandry, and more particularly to autonomously navigating and interacting with animals and livestock, including poultry.

### BACKGROUND

Poultry are commonly raised in poultry barns, such as broiler barns (or houses), turkey barns, and the like. Similarly, livestock and other animals are commonly raised in pens, barns, enclosed structures, and other environments.

While being raised, the animals, as well as their surroundings and environment must be maintained. For example, encouraging healthy movement among animals is crucial for the animals' well-being and productivity in the livestock industry. Lack of movement can lead to obesity, poor muscle development, and other health issues in animals. However, excessive or forced movement can lead to stress and anxiety among the animals. There is a need for a solution that encourages animals to move in a controlled and healthy manner, balancing the need for exercise with the need to minimize stress. Existing solutions have several limitations, including not being able to dynamically interact with the animals and environment and adjust in real-time to changing needs of the animals. Further, existing solutions are not suitable for all types of animals or environments, are not efficient, and can require significant manual intervention. Thus, there is a need for solution that addresses these limitations and others, including the dynamic adjustability to the needs of the animals and the environment, suitability for all types of animals, and efficiency in terms of energy consumption and manual intervention. Additionally, a need exists for a solution that can monitor the animals, care for the animals, and/or navigate and maintain the environment in which the animals are being raised, all while navigating the animals and other environmental obstacles and/or moving the animals in its path.

Additionally, prior to harvesting the poultry, a number of animals may prematurely die. The removal of such expired poultry is critical to maintain proper sanitation and to ensure the viability of the living stock of poultry. Removal of expired poultry in barns is frequently a time-consuming process that requires significant amounts of human labor. To remove the expired poultry a human operator must manually walk around the poultry barn and pick up the expired poultry. However, prolonged exposure of the human operator to poultry dust and gases within poultry environments (e.g., barns) may have a deleterious effect. Therefore, it would be advantageous to provide one or more of a device, system, or method that provides for the removal of the expired poultry.

### BRIEF SUMMARY OF THE INVENTION

The present invention is directed generally to an autonomous vehicle, “caretaker” device, or navigation device and a navigation system therefor. In one embodiment, the navigation device may include a chassis, one or more drive wheels for propelling the navigation device, and a caster wheel for providing steering assistance and balance. The navigation device may include a spinner assembly with rotatable flexible members to encourage movement of animals in the forward path of the navigation device. In other embodiments, other types of animal movement encouragement devices may be utilized in addition to or in place of the spinner assembly. The navigation device may include cameras, LiDAR sensors, and other sensor units to detect and map animals around and in the path of the navigation device.

The present invention is also directed to an autonomous navigation system that controls the navigation device for various pathing or interactions with the animals. The navigation system may read or process inputs from a camera feed or other sensor units. The navigation system may detect animals and their locations using machine learning based on those inputs. The navigation system may then label each animal with a unique identification and track each animal. The navigation system may then categorize each animal into various zones around the navigation device, with more critical zones nearer the navigation device and its immediate forward path and less critical zones farther away from the navigation device and its immediate forward path. Based on which zone(s) are occupied by an animal, the navigation system may operate under various maneuvers to continue on its path while encouraging animals to move out of its forward path. The animal tracking may also be used to create a 2-D animal occupancy grid of the environment. The navigation system may also create an occupancy grid of non-animal objects and a static barn map grid. The animal occupancy grid, the non-animal objects grid, and the static barn map grid may be combined to created a condensed occupancy grid. The navigation system may use the condensed occupancy grid to formulate and plan its path through the environment and to control the navigation system to follow the path. This navigation system process may be iteratively repeated for the navigation device to traverse the environment and complete selected tasks.

The various maneuvers the navigation system may operate under various conditions of drive wheel speed, spinner assembly speed, spinner assembly direction, and other auxiliary maneuvers depending on the location of animals relative to the navigation device as well as the relevant animal's size/age. The navigation device and navigation system may be utilized to manage an animal environment and interact with the animals in a variety of ways.

The navigation system may also be used to perform a variety of tasks or to achieve various goals or objectives. These tasks and objectives can require different planned paths and interactions throughout the animal environment. The navigation system may generate a set of waypoints and navigate those waypoints to path or navigate through the environment as desired. The navigation device may collect, log, and communicate information related to the animals and/or environment to a remote operator or dispatch system. The navigation system may also alert the remote operators or dispatch system of any irregularities or in operation of the navigation system or send requests for intervention or assistance. The operators may remotely address these alerts and requests or may alert on-site personnel to address the same.

In one embodiment, a navigation device for navigating an animal environment comprises a chassis, one or more drive wheels for propelling the navigation device, at least one sensor unit for detecting animals and the environment, the at least one sensor unit configured to communicate with a navigation system to generate a set of waypoints to define a planned path for the navigation device, and a controller for controlling operation of the one or more drive wheels to move the navigation device along the planned path.

In another embodiment, a method of controlling a navigation device for navigating an animal environment is provided. The method comprises processing input information from a sensor unit to determine a location of animals and obstacles in the animal environment, generating a map of the animal environment and the animals located therein, generating a set of waypoints that define a planned path through the environment, and controlling movement of at least one drive wheel of the navigation device to direct the navigation device along the planned path.

In another embodiment, a navigation device for navigating an animal environment including a gate is provided. The navigation device comprises a chassis, a drive wheel, one or more sensor units for detecting animals and the environment, the one or more sensor units configured to communicate with a navigation system to generate a set of waypoints to define a planned global path for the navigation device that passes through an opening in the gate, and a controller for controlling operation of the drive wheel to move the navigation device along the planned global path. At least one of the one or more sensor units is configured to detect a fiducial marker positioned on the gate to accurately determine a pose of the gate relative to the navigation device.

In another embodiment, a navigation device for navigating an animal environment comprises a chassis, one or more drive wheels for propelling the navigation device in a forward path, at least one sensor unit for detecting animals, an animal movement encouragement device, and a controller for controlling operation of the one or more drive wheels and the animal movement encouragement device. The animal movement encouragement device has at least two or more operating settings. One of the two or more operating settings is automatically selected based on a relative location of an animal to the navigation.

In another embodiment, a method of controlling a navigation device for navigating an animal environment is provided. The method comprises processing input information from a sensor unit to determine a location of animals in the animal environment, generating a map of the animal environment and the animals located therein, categorizing each animal into one of a plurality of zones based on each animal's relative location to the navigation device and a planned forward path of the navigation device, and controlling movement of at least one drive wheel of the navigation device based on which zone of the plurality of zones that each animal is categorized into.

In another embodiment, a navigation device for navigating an animal environment comprises a chassis, a drive wheel, a sensor unit for detecting animals, an animal movement encouragement device, and a controller for controlling operation of the drive wheel and the animal movement encouragement device. The controller sets the drive wheel to a speed based on a relative location of an animal to the navigation device.

Other and further objects of the invention, together with the features of novelty appurtenant thereto, will appear in the course of the following description.

### BRIEF DESCRIPTION OF THE SEVERAL VIEWS OF THE DRAWING

In the accompanying drawings, which form a part of the specification and are to be read in conjunction therewith in which like reference numerals are used to indicate like or similar parts in the various views:

FIG. 1A illustrates a side view of a navigation device, in accordance with one or more embodiments of the present disclosure;

FIG. 1B illustrates a front view of a navigation device, in accordance with one or more embodiments of the present disclosure;

FIG. 1C illustrates a top view of a navigation device, in accordance with one or more embodiments of the present disclosure;

FIG. 1D illustrates a top view of a navigation device with a deterrent spinner deployed, in accordance with one or more embodiments of the present disclosure;

FIG. 2 illustrates a simplified schematic diagram of a control system of a navigation device, in accordance with one or more embodiments of the present disclosure;

FIG. 3 illustrates a flow diagram of a method of mortality recovery, in accordance with one or more embodiments of the present disclosure;

FIGS. 4A-4H illustrates a side view of a navigation device implementing a method of mortality recovery, in accordance with one or more embodiments of the present disclosure;

FIGS. 5A-5C illustrates a top view of a navigation system, in accordance with one or more embodiments of the present disclosure;

FIG. 6A illustrates a perspective view of a navigation device, in accordance with one or more embodiments of the present disclosure;

FIG. 6B illustrates a side view of a navigation device, in accordance with one or more embodiments of the present disclosure;

FIG. 6C illustrates a rear perspective view of a navigation device, in accordance with one or more embodiments of the present disclosure;

FIG. 6D illustrates a rear view of a navigation device, in accordance with one or more embodiments of the present disclosure;

FIG. 7A illustrates a perspective view of a navigation device, in accordance with one or more embodiments of the present disclosure;

FIG. 7B illustrates a side view of a navigation device, in accordance with one or more embodiments of the present disclosure;

FIG. 7C illustrates a perspective view of a drive wheel of a navigation device, in accordance with one or more embodiments of the present disclosure;

FIG. 8 illustrates a flow diagram of a navigation system, in accordance with one or more embodiments of the present disclosure;

FIG. 9 illustrates a top schematic view of a navigation device and its surrounding environment, in accordance with one or more embodiments of the present disclosure;

FIG. 10A illustrates a flow diagram of a navigation maneuver of a navigation device, in accordance with one or more embodiments of the present disclosure;

FIG. 10B illustrates a flow diagram of a navigation maneuver of a navigation device, in accordance with one or more embodiments of the present disclosure;

FIG. 10C illustrates a flow diagram of a navigation maneuver of a navigation device, in accordance with one or more embodiments of the present disclosure;

FIG. 10D illustrates a flow diagram of a navigation maneuver of a navigation device, in accordance with one or more embodiments of the present disclosure;

FIG. 11A illustrates a portion of a schematic of a barn environment mapping, in accordance with one or more embodiments of the present disclosure;

FIG. 11B illustrates a portion of a schematic of a barn environment mapping, in accordance with one or more embodiments of the present disclosure;

FIG. 12 illustrates a flow diagram of a navigation system, in accordance with one or more embodiments of the present disclosure;

FIG. 13 illustrates a flow diagram of a navigation system, in accordance with one or more embodiments of the present disclosure;

FIG. 14 illustrates a flow diagram of a navigation system, in accordance with one or more embodiments of the present disclosure;

FIG. 15 illustrates a schematic of a communication and dispatch system, in accordance with one or more embodiments of the present disclosure; and

FIG. 16 illustrates a flow diagram of an automated system, in accordance with one or more embodiments of the present disclosure.

### DETAILED DESCRIPTION OF THE INVENTION

Various embodiments of the present invention are described and shown in the accompanying materials, descriptions, instructions, and drawings. For purposes of clarity in illustrating the characteristics of the present invention, proportional relationships of the elements have not necessarily been maintained in the drawings. It will be understood that any dimensions included in the drawings are simply provided as examples and dimensions other than those provided therein are also within the scope of the invention.

The description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

Embodiments of the present disclosure are directed to an autonomous vehicle, “caretaker” device, or navigation device for caretaking or interacting with animals. For example, the navigation device may be used to encourage animal movement, provide food, administer vaccines or other medicines, clean or service a barn or other animal enclosure or environment, etc. The navigation device may also be configured to autonomously path within a confined space, such as a broiler barn or the like, by one or more of obstacle detection or environmental mapping. In the livestock industry, encouraging healthy movement among animals is crucial for the animals' well-being and productivity. Lack of movement can lead to obesity, poor muscle development, or other health issues in animals. Conversely, excessive or forced movement can lead to stress and anxiety among the animals. Therefore, a navigation device is disclosed that encourages animals to move in a controlled and healthy manner, balancing the need for animal exercise with the need to minimize stress in the animals. Moreover, the navigation device disclosed is a dynamic and automated solution that can adjust in real-time to the needs of the animals, is suitable for use with a variety of types of animals, and is efficient in terms of energy consumption and reduces any manual intervention. The navigation device is suitable for use with various types of animals. At times this disclosure and figures may reference the navigation device interacting with birds or poultry as an example of an animal, but these references are in no way intended to limit this disclosures applicability to other types of animals.

The navigation device may also detect an expired poultry within the environment by an image recognition method. In one embodiment, the navigation device may be configured to perform mortality recovery of an expired poultry. For example, the navigation device may include a linkage assembly that may sweep and rotate an expired poultry into a container (also referred to as a dead box) for recovering the expired poultry from the environment.

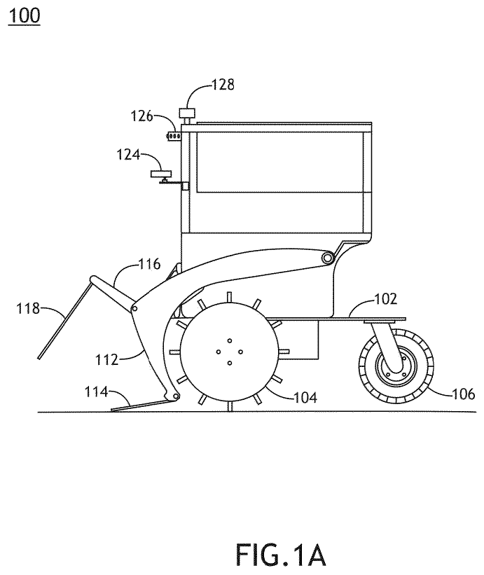

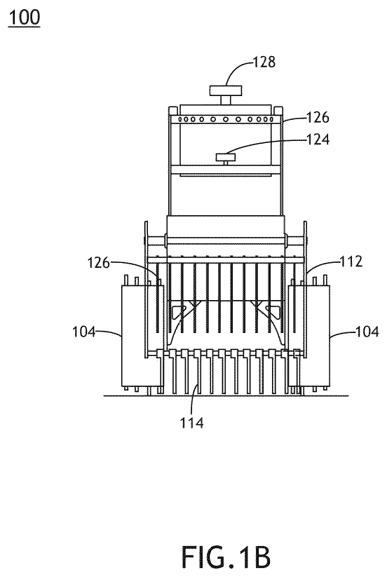

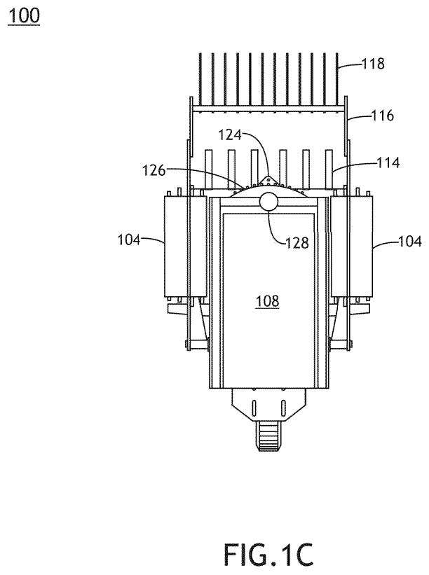

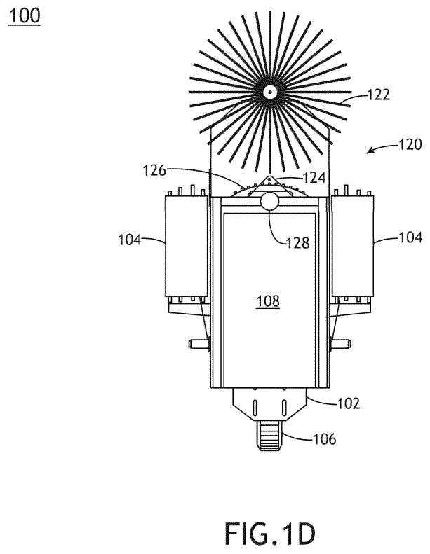

Referring now to FIGS. 1A-1D, a navigation device 100 is described in accordance with one or more embodiments of the present disclosure. The navigation device 100 may include one or more of a chassis 102, drive wheels 104, caster wheel 106, container 108, linkage assembly 110, spinner assembly 120, and one or more sensors. Various components of the navigation device 100 may be coupled to the chassis 102, such as, but not limited to, the drive wheels 104, caster wheel 106, the container 108, the linkage assembly 110, the spinner assembly 120, or the sensors. By the arrangement of the various components, the navigation device 100 may be provided to autonomously travel within a poultry barn to encourage animal movement, provide food, administer vaccines or other medicines, clean or service the barn, and/or recover expired poultry from a ground surface of the barn.

The drive wheels 104 may propel the chassis in a forward path. In this regard, the drive wheels may be selectively rotated by one or more drive wheel motors 208, or the like. In embodiments, the drive wheels 104 include a spiked tread (e.g., a tread with rods integrated into one or more portions of the wheels, where the rods may be configured to provide traction, till, and/or break up debris or other material disposed within a poultry environment). The spiked tread may provide for tiling a bedding of as the drive wheels 104 are rotated. In this regard, the plurality of wheels may be configured to reduce a buildup of noxious and/or harmful substances within the poultry environment (e.g., ammonia). It is further contemplated that the drive wheels 104 may include any wheel known in the art, such as, but not limited to, a rubber tread or a continuous wheel (also known as continuous track or caterpillar track), and the like. In embodiments, the drive wheels 104 are independently controllable for propelling and turning the chassis. By the independent control of the drive wheels 104, the navigation device 100 may be considered to include differential steering (also referred to as skid steer). In embodiments, the navigation device 100 may include a zero-degree turning radius by the independent control of the first drive wheel and the second drive wheel which may be advantageous for navigating within enclosed environments, such as broiler barns and the like. Although the drive wheels 104 are described as being independently controlled, this is not intended as a limitation of the present disclosure. In this regard, the navigation device 100 may include a steering mechanism for torque steering the navigation device 100.

In embodiments, the navigation device 100 includes one or more caster wheels 106. As depicted, the caster wheels 106 may be disposed behind the drive wheels 104, relative to the forward path of the navigation device 100. Such caster wheels 106 may be pivotably mounted, such that the caster wheels 106 may automatically align themselves with the direction of travel. By the caster wheels 106, the navigation device 100 may include the zero-degree turning radius. Although the navigation device 100 is described as including the caster wheels 106, this is not intended as a limitation on the present disclosure. In this regard, the navigation device 100 may include one or more additional drive wheels, which may or may not be independently controllable. The navigation device 100 may also include one or more idler wheels or the like. In this regard, the navigation device 100 may include various permutations of drive wheels, idler wheels, caster wheels, front steering, rear steering, or skid steering to accomplish steering and propulsion.

The navigation device 100 may also include the container 108 coupled to the chassis 102. The container 108 may act a dead box storage for expired poultry. In embodiments, the container 108 is pivotably mounted to the chassis 102. A container motor 216 may also be coupled between the container 108 and the chassis 102 for pivoting the container relative to the chassis for dumping expired poultry (e.g., dumping from a rear).

In embodiments, the navigation device 100 includes the linkage assembly 110 coupled to the chassis 102. The linkage assembly 110 may include one or of a lift member 112, platform 114, grapple member 116, or tines 118. The linkage assembly 110 may function as a skid-loader lift or actuator arm that conveys expired poultry from the ground into the container 108, as described further herein.

The lift member 112 may be coupled to the chassis 102 and include the platform 114. For example, the lift member 112 may be pivotably coupled to the chassis 102. By the pivotable connection, the lift member 112 may be rotated relative to the chassis 102 for lifting the platform 114 from the ground to a position above the container 108. The platform 114 may also be rotated to dump the expired poultry into the container 108. The pivotable action of the lift member 112 may be provided by a lift motor 210 (e.g., an electric motor, a linear actuator, or the like). In embodiments, the platform 114 includes one or more tines. The tines may be spaced to allow bedding to pass through the tines, such that the bedding is not conveyed to the container 108 by the platform 114. Such tines may include, but are not limited to, tines with a length between four and ten inches. Although the platform 114 is described as including tines, this is not intended as a limitation on the present disclosure. In this regard, the platform 114 may generally include any shape which is suitable for conveying the expired poultry to the container 108. In embodiments, the platform 114 is spring-mounted to the lift member 112. By the spring mount, the platform 114 may be rotated relative to the lift member 112 when the platform 114 is raised above container 108.

The grapple member 116 may be coupled to the lift member 112 and include one or more tines 118. For example, the grapple member 116 may be pivotably coupled to the lift member 112. By the pivotable connection, the grapple member 116 may be rotated relative to the lift member 112 for moving the tines 118 towards the platform 114. The movement of the tines 118 towards the platform 114 may cause the tines 118 to rake expired poultry onto the platform 114. The pivotable action of the grapple member 116 may be provided by a grapple motor 212 (e.g., an electric motor, a linear actuator, or the like). In a similar fashion to the tines of the platform 114, the tines 118 may be spaced to allow bedding to pass through the tines 118, such that the bedding is not raked onto the platform 114. Such tines may include, but are not limited to, tines with a length between four and ten inches. Although the grapple member 116 is described as including the tines 118, this is not intended as a limitation on the present disclosure. In this regard, the grapple member 116 may generally include any shape which is suitable for raking the expired poultry onto the platform 114. In embodiments, the grapple member 116 translates the tines 118 upwards as the platform 114 is raised for clamping the expired poultry between the tines 118 and the platform 114. By the clamping, the expired poultry may be prevented from falling off of the platform 114 prior to the platform 114 being raised above the container 108. The tines 118 may remain clamped for some portion of the upward motion, such as, but not limited to, when the platform 114 is disposed above the container 108. As may be understood, the specific duration of the clamping may be selectively adjusted based on kinematic chain (also referred to as rigid body) design methodologies.

In embodiments, the navigation device 100 includes the spinner assembly 120. The spinner assembly 120 may include one or more flexible members 122. Such flexible members 122 may include, but are not limited to, a plastic material with a length between 12 and 36 inches. The spinner assembly 120 may retain the flexible members 122 in a hub that attaches to a spinner motor 206. By the spinner motor 206, the spinner assembly 120 may rotate the flexible members 122 for deterring live poultry from a forward path of the navigation device 100, thereby evacuating the live poultry from the drive wheels 104, the grapple member 116, or the platform 114. In some instances, the spinner assembly 120 may rotate the flexible members 122 parallel to the ground, although this is not intended to be limiting. It is contemplated that by rotating the flexible members 122 parallel to the ground, live poultry in a forward path of the navigation device 100 may be deterred to a side of the navigation device 100.

In embodiments, the spinner assembly 120 may be positioned between an extended position and a retracted position. In this regard, the spinner assembly 120 may include one or more linkages and an actuator for retracting or extending the spinner assembly 120. For example, the spinner assembly 120 may be extended for deterring poultry from the forward path. Upon detection of an expired poultry, the spinner assembly 120 may then be retracted. By retracting the spinner assembly 120, a likelihood of the flexible members 122 becoming entangled with the tines 118 or the platform 114 may be reduced. The spinner assembly 120 may be retracted and/or folded within a stowage compartment.

In embodiments, the navigation device 100 includes one or more sensor units, such as, but not limited to, camera, LiDAR, proximity sensor, proximity switches, global positioning (GPS) sensors, and the like. The sensor units may measure one or more signals indicative of one or more conditions within the poultry environment. For example, the sensors may include, but are not limited to, a camera 124, a camera 126, or a camera 128. The sensors may provide various data for autonomously controlling a pathing of the navigation device 100, avoiding obstacles, and detecting live or expired poultry. Such cameras may be coupled to one or more components of the navigation device 100, such as, but not limited to, the chassis 102. As may be understood, the various cameras described herein may include any suitable camera known in the art, such as, but not limited to, a charge couple device (CCD) detector, a complementary metal-oxide semiconductor (CMOS), or the like. Furthermore, the camera 124, the camera 126, or the camera 128 may optionally include a light source for illuminating an image stream captured by the associated camera.

In embodiments, the navigation device 100 may include the camera 124. The camera may be considered an animal detection camera. In this regard, the camera 124 may be posed (positioned and oriented) on the navigation device 100 such that the camera 124 is configured to capture an image stream including an area disposed in the forward path of the navigation device 100. Such area may include, but is not limited to, an area between the platform 114 and the tines 118. The area between the platform 114 and the tines 118 may be beneficial for generating sensor data indicative of expired poultry which are ready for grappling by the tines 118. In this regard, the camera 124 may generally be pointed at the ground in front of the navigation device 100. The image stream from the camera 124 may then be provided to one or more processors 202 for detecting expired poultry and/or live poultry within the forward path. In response to detecting the live poultry, the spinner motor 206 may be engaged for deterring the live poultry. In response to detecting the expired poultry, the processors 202 may provide control signals to the grapple motor 212 and the lift motor 210 for conveying the expired poultry to the container 108.

In embodiments, the camera 124 may also be considered an object detection camera. In this regard, the camera 124 may be posed on the navigation device 100 such that the camera 124 is configured to capture an image stream including an area disposed at a height of between four and forty-eight inches from the ground. By being disposed at such height, the camera may capture an image stream which may be advantageous in identifying objects within a poultry barn, such as a feed line or a water line. It is further contemplated that one or more additional cameras may be provided for the object detection purposes, such as, but not limited to, the camera 126. The image stream from the camera 124 may be provided to the processor 202 for detecting the obstacles. The processors 202 may also provide control signals to the drive wheel motors 208 based on the obstacles within the image stream of the camera 124, for avoiding the obstacles.

In embodiments, the angle-of-view of the camera 124 is sufficient to capture both the ground and one or more of the feed lines or water lines. In embodiments, the navigation device 100 includes both of the camera 124 and the camera 126. The camera 126 may be considered an object detection camera. In this regard, the camera 126 may be posed such that the camera 126 is configured to capture an image stream including the area at the height of between four and forty-eight inches from the ground. The area disposed at a height of between four and forty-eight inches from the ground may be advantageous in identifying objects within a poultry barn, such as said feed lines or water lines. In a similar fashion to the image stream from the camera 124, the image stream from the camera 126 may be provided to the processor 202 for detecting the obstacles and providing control signals to the drive wheel motors 208 based on the obstacles detected within the image stream of the camera 126. In some instances, multiple of the camera 126 may be provided, such as, for one or more sides of the navigation device 100. In embodiments, the camera 126 is a stereo camera including two or more lenses for capturing three-dimensional images. Such three-dimensional images may be advantageous in assisting the processor 202 in detecting obstacles within the environment.

In embodiments, the navigation device 100 may include the camera 128. The camera 128 may be considered a mapping camera. In this regard, the camera 128 is posed such that the camera 128 is configured to capture an image stream including at least a portion of a ceiling disposed above the navigation device 100. The camera 128 may include a fisheye lens with an angle-of-view between one-hundred and one-hundred eighty degrees. The angle-of-view between one-hundred and one-hundred eighty degrees may be advantageous in capturing a significant portion of the ceiling within the image stream. By capturing the ceiling, a map of the surrounding environment may be generated. The image stream may be provided to the processors 202 for generating the map, determining a pose of the autonomous navigation device 100 within the map, and providing control signals to the drive wheel motors 208 based on the image stream from the camera 128 for navigating the navigation device within the environment.

Although the navigation device 100 is described as including the camera 128, this is not intended as a limitation of the present disclosure. In embodiments, the navigation device 100 may include a light detection and ranging (LiDAR) sensor 214, or the like. In a similar fashion to the camera 128, the LiDAR sensor 214 may be posed on the navigation device 100 for navigation purposes. The LiDAR sensor 214 may capture a point cloud indicative of a distance from the navigation device 100 to one or more portions of the ceiling. The point cloud may be provided to the processors 202 for generating the map, determining a pose of the autonomous navigation device 100 within the map, and providing control signals to the drive wheel motors 208 based on the point cloud from the LiDAR sensor 214 for navigating the navigation device 100 within the environment.

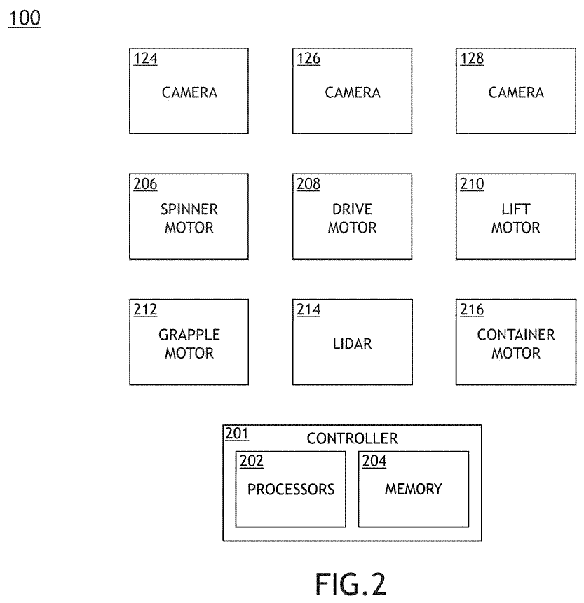

Referring now to FIG. 2, a simplified block diagram of the navigation device 100 is described, in accordance with one or more embodiments of the present disclosure. In embodiments, the navigation device 100 includes a controller 201 including one or more processors 202 and a memory 204. The processors 202 may be communicatively coupled to one or more components of the navigation device 100, such as, but not limited to, the camera 124, the camera 126, the camera 128, the spinner motor 206, the drive wheel motor 208, the lift motor 210, the grapple motor 212, the LiDAR 214, or the container motor 216. The processors 202 may also be configured to execute one or more sets of program instructions stored in the memory 204, by which the processors 202 may be configured to carry out one or more steps of the present disclosure. The program instructions may include one or more algorithms, such as, but not limited to, a computer vision algorithm, a machine learning algorithm, a deep learning algorithm, visual simulation location and mapping (VSLAM) algorithm, a navigation algorithm, or the like. In embodiments, the one or more processors 202 may be configured to one or more of generate a map of a poultry environment (e.g., based on markings from the ceiling), provide one or more autonomous navigation signals based on the map, detect one or more feed lines or water lines within the poultry environment, provide one or more autonomous navigation signals based on the detect feed lines or water lines, detect one or more poultry within the poultry environment, determine an expiration condition of the one or more poultry, or provide controls to one or more components of the navigation device 100 for retrieving the expired poultry.

The one or more processors 202 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 202 may include any device configured to execute algorithms and/or instructions (e.g., program instructions stored in memory). In embodiments, the one or more processors 202 may be embodied as a desktop computer, image computer, parallel processor, networked computer, or any other computer system configured to execute a program instruction as described throughout the present disclosure. Further, the steps described throughout the present disclosure may be carried out by a single processor or multiple processors. Additionally, the controller 201 may include one or more processors housed in a common housing or within multiple housings. In this way, any controller or combination of controllers may be separately packaged as a module suitable for integration into the navigation device 100. Further, the processors 202 may analyze data received from the various sensors and feed the data to additional components within the navigation device 100 or external to the navigation device 100.

The memory 204 may include any storage medium known in the art suitable for storing program instructions executable by the associated one or more processors 202. For example, the memory 204 may include a non-transitory memory medium. By way of another example, the memory 204 may include, but is not limited to, a read-only memory (ROM), a random-access memory (RAM), a magnetic or optical memory device (e.g., disk), a solid-state drive and the like. It is further noted that memory 204 may be housed in a common controller housing with the one or more processors 202. In one embodiment, the memory 204 may be located remotely with respect to the physical location of the one or more processors 202 and controller 201. For instance, the one or more processors 202 of controller 201 may access a remote memory (e.g., server), accessible through a network (e.g., internet, intranet and the like). In embodiments, the memory maintains program instructions for causing the one or more processors to carry out the various steps described through the present disclosure.

In embodiments, the processors 202 may be configured to receive one or more signals indicative of one or more conditions within the poultry environment from one or more sensor units of the navigation device 100. The one or more conditions within the poultry environment my include, but are not limited to, one or more obstacles (e.g., feed line, or water line), one or more poultry birds, one or more expiration conditions of one or more poultry birds (e.g., one or more signals indicative of a dead bird and/or one or more signals indicative of a live bird), or one or more maps of the poultry environment. The map may dictate locations of anomalies within a barn and provide markings of the ceiling for assisting with object detection or autonomous navigation. The map may be generated from an image stream or a point cloud of a ceiling using a visual simulation location and mapping (VSLAM) algorithm, or the like. In another regard, the signals indicative of one or more conditions within the poultry environment collected by the one or more sensor units may be configured to allow the processors 202 to generate maps of the poultry environment and/or identify expired poultry within the poultry environment.

In embodiments, the processors 202 may be configured to provide one or more control signals to one or more portions of the navigation device 100 based on the one or more signals indicative of one or more conditions within the poultry environment. For example, the processors 202 may be configured to provide one or more control signals to one or more propulsion systems (e.g., the drive wheel motor 208) for autonomously pathfinding within the poultry barn, such that the navigation device 100 may approach an expired bird for recovery. In this regard, the signals indicative of one or more conditions within the poultry environment collected by the one or more sensor units may be configured to allow the navigation device 100 to navigate (e.g., either autonomously or in response to one or more control signals, including, without limitation, control signals provided by a user) within the poultry environment. The one or more sensor units may be configured to allow the navigation device 100 to avoid obstacles within the poultry environment (e.g., feeders, waterers, fences, walls, humans, birds, or the like). By way of another example, upon determination of a presence of one or more live poultry, the processors 202 may be configured to provide one or more control signals to the one or more poultry avoidance sub-systems (e.g., the spinner motor 206) such that the one or more poultry avoidance sub-systems cause the unexpired poultry birds to evacuate an area near the navigation device 100. The evacuation of the live poultry may then allow the navigation device 100 to resume pathfinding without injuring the live poultry. By way of another example, upon determination of an existence of one or more expired poultry birds, the processors 202 may be configured to provide one or more control signals to one or more poultry retrieval sub-systems, where the control signals are configured to cause the one or more poultry retrieval sub-systems to recover the expired poultry.

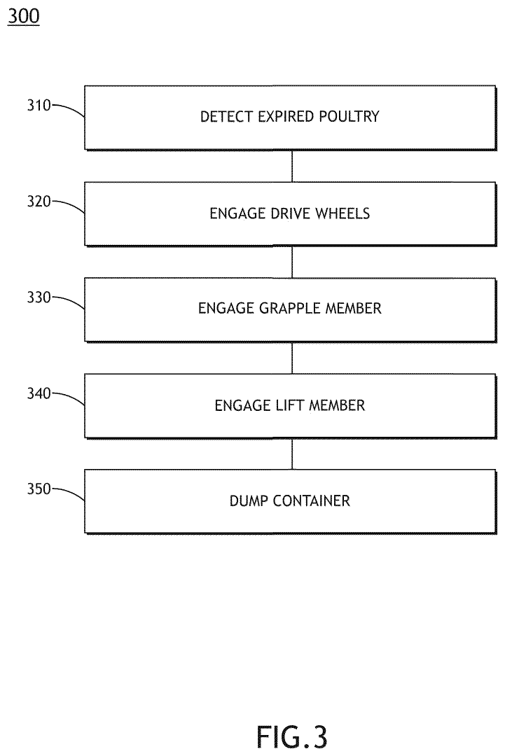

Referring now to FIG. 3, a flow diagram of a method 300 is described, in accordance with one or more embodiments of the present disclosure. The embodiments and the enabling technology described previously herein in the context of the navigation device 100 should be interpreted to extend to the method 300. For example, one or more steps of the method 300 may be implemented by the processors 202 executing software-executable codes. It is further recognized, however, that the method 300 is not limited by the navigation device 100.

In a step 310, an expired poultry is detected in an image from a camera. The expired poultry may be detected by applying an image recognition model to the image. The image recognition model may include any suitable image recognition model, such as, but not limited to, a blob detection model or a pretrained imaged detection model. The blob detection model may compare a color offset between the bedding and the expired poultry. The pretrained image detection model may be trained with annotated images of barn data using one or more machine learning algorithms, such as, but not limited to, a classification algorithm. In some instances, a spinner motor is disengaged and a spinner assembly is retracted upon detecting the expired poultry.

In a step 320, one or more drive wheels are engaged to position the expired poultry between a grapple member and a platform. The drive wheels may be engaged by providing one or more control signals from a processor to a drive wheel motor causing drive wheels to be rotated. In a step 330, a grapple member is engaged to convey expired poultry onto the platform. The grapple member may be engaged by providing one or more control signals from the processor to a grapple motor causing the grapple to rotate relative to the lift member.

In a step 340, a lift member is engaged to convey the expired poultry from the platform into a container. The lift member may be engaged by providing one or more control signals from the processor to a lift motor causing the lift member to rotate relative to a chassis. Subsequent to conveying the expired poultry to the container, the spinner assembly may be extended. The navigation device 100 may then resume autonomous navigation of the environment.

Optionally, in a step 350, the container is dumped. The container may be dumped by engaging a container motor 216 causing the container to rotate relative to a chassis for dumping the expired poultry within the container from a rear opening of the container. The container may be dumped upon a given number of expired poultry being received within the container. Furthermore, the container may be selectively positioned to a dump location which is suitable for receiving the expired poultry.

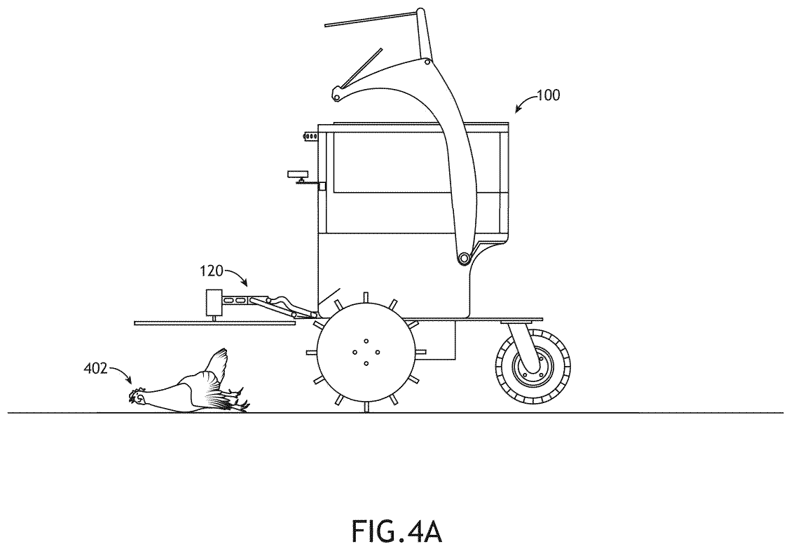

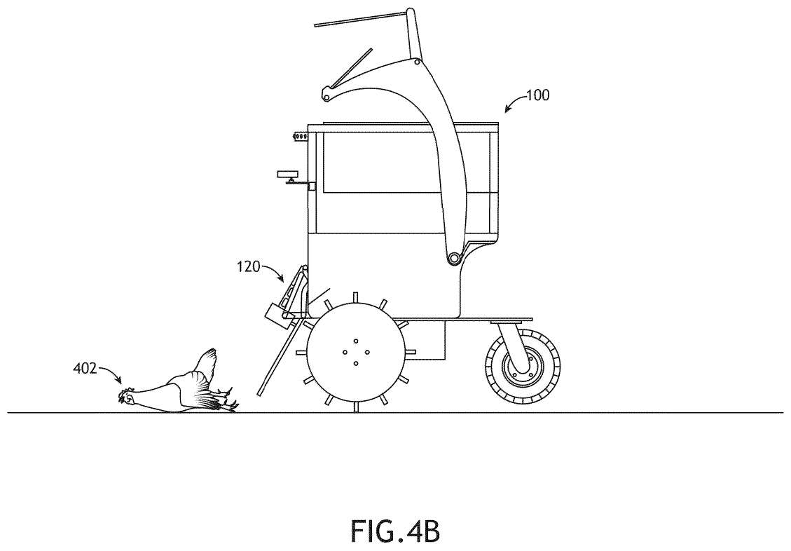

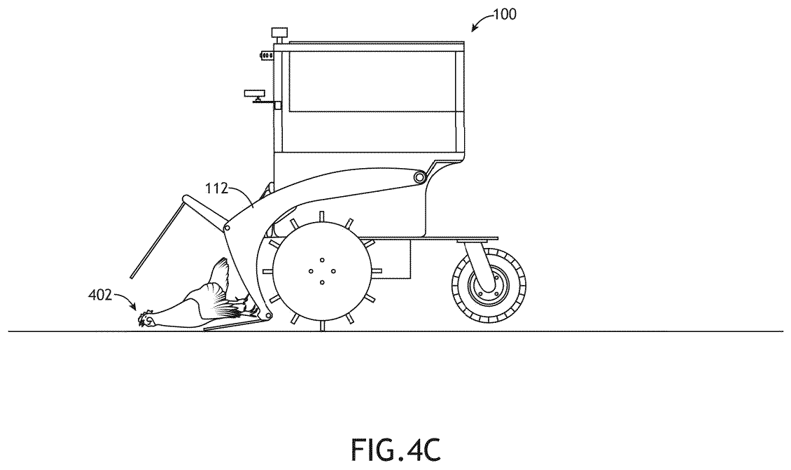

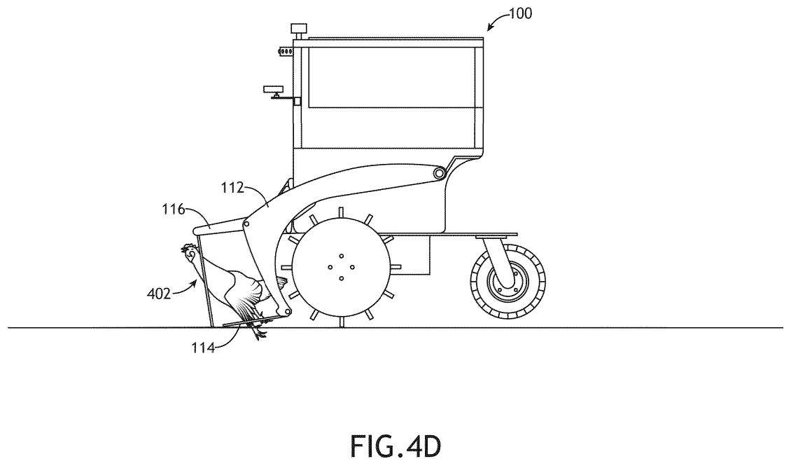

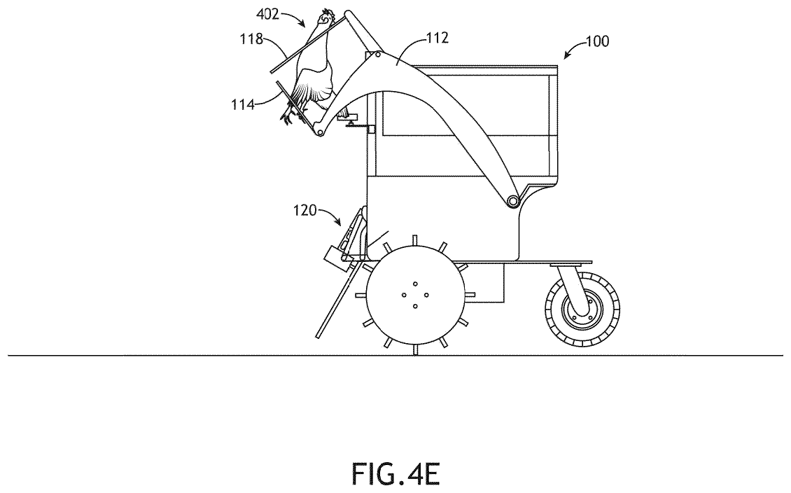

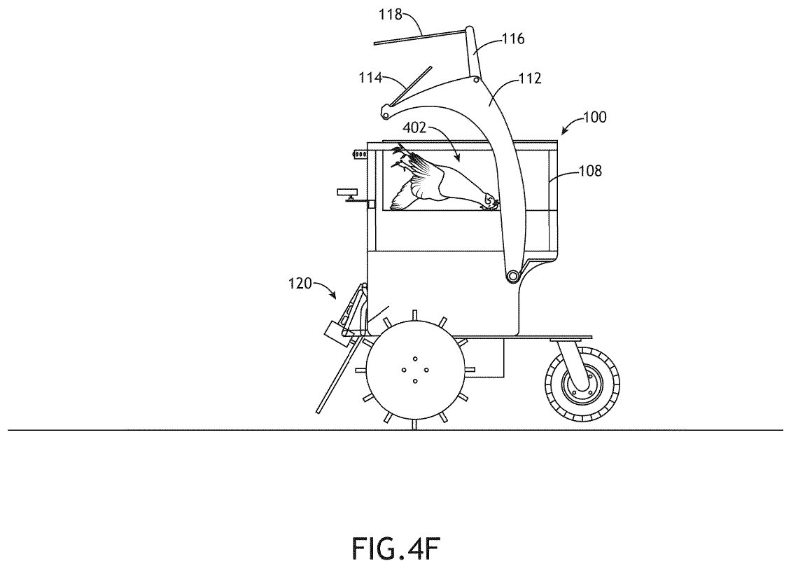

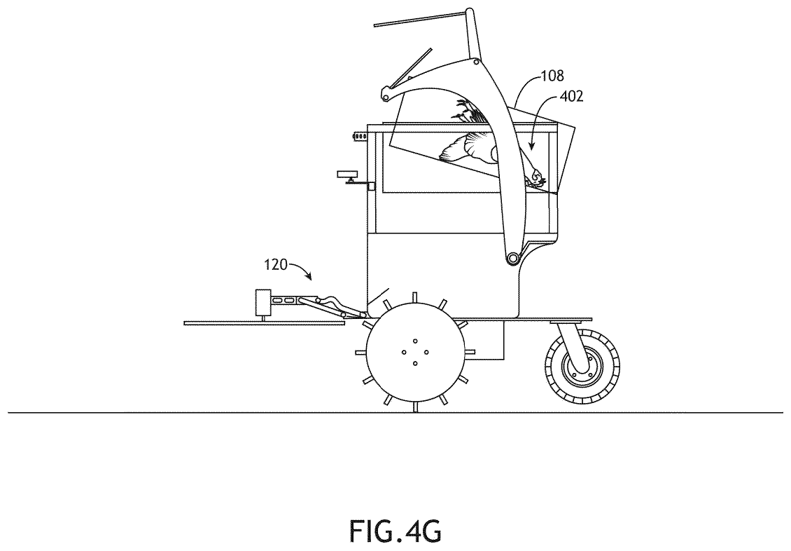

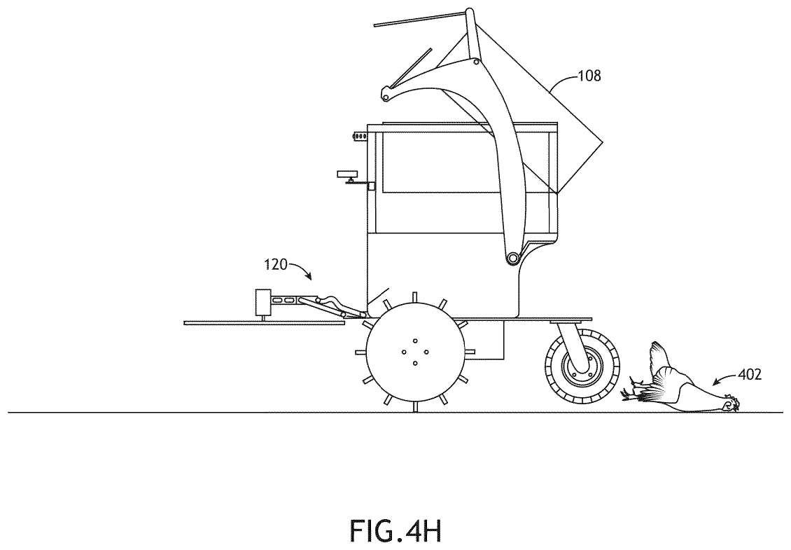

Referring generally to FIGS. 4A-4H, an exemplary implementation of the method 300 by the navigation device 100 is described, in accordance with one or more embodiments of the present disclosure. Referring now to FIG. 4A, the navigation device 100 may move autonomously within a barn environment and include a spinner assembly 120 in an extended position for deterring live poultry from the forward path. The navigation device 100 may also capture an image stream of an expired poultry 402 in a forward path (e.g., by the camera 124). Referring now to FIG. 4B, the navigation device 100 may retract the spinner assembly 120 in response to detecting the expired poultry. Referring now to FIG. 4C, the navigation device 100 may deploy the linkage assembly 110 to a ground level in response to retracting the spinner assembly 120. The navigation device 100 may also position the expired poultry between the tines 118 of the grapple member and the platform 114 by engaging the drive wheels 104. Referring now to FIG. 4D, the navigation device 100 may engage the grapple member 116 for conveying the expired poultry 402 onto the platform 114 by way of the tines 118. Referring now to FIGS. 4E-4F, the navigation device 100 may engage the lift member 112 to raise the platform 114 above the container 108 and drop the expired poultry 402 in the container 108. As the lift member 112 is rotated, the tines 118 may clamp the expired poultry 402 to the platform 114 for a least a portion of the time as the expired poultry 402 is raised. Referring now to FIGS. 4G-4H, the spinner assembly 120 may be extended and the navigation device 100 may renew the autonomous movement within the barn environment. As depicted, the navigation device 100 has moved to a dump location. The container 108 may then be rotated to dump the expired poultry 402 from the container 108 at the dump location. By such autonomous recovery and dumping of the expired poultry, a human requirement to recover the expired poultry from the barn may be eliminated.

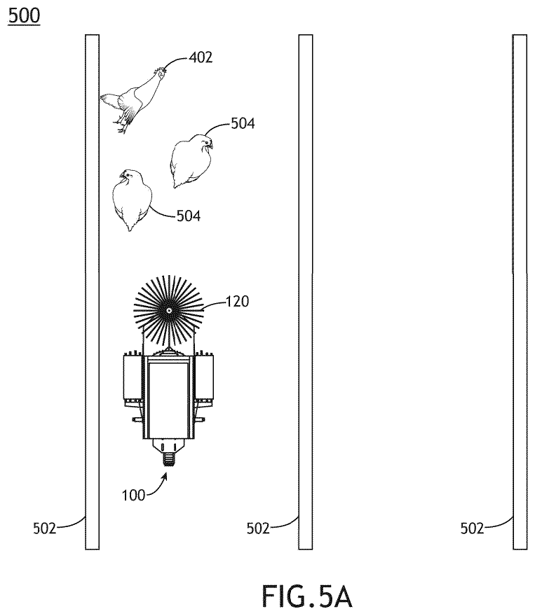

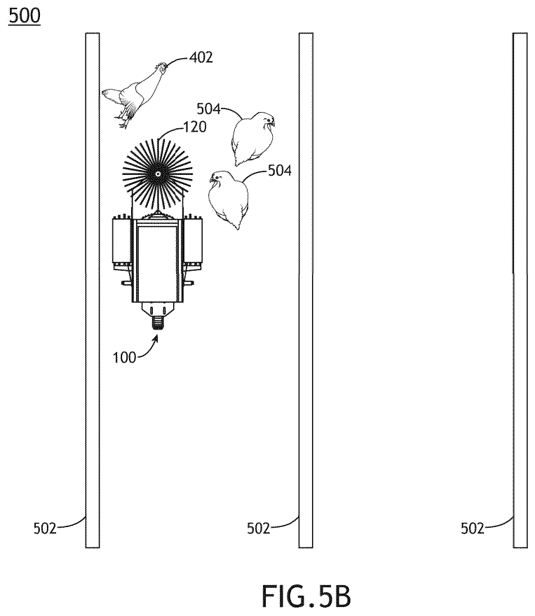

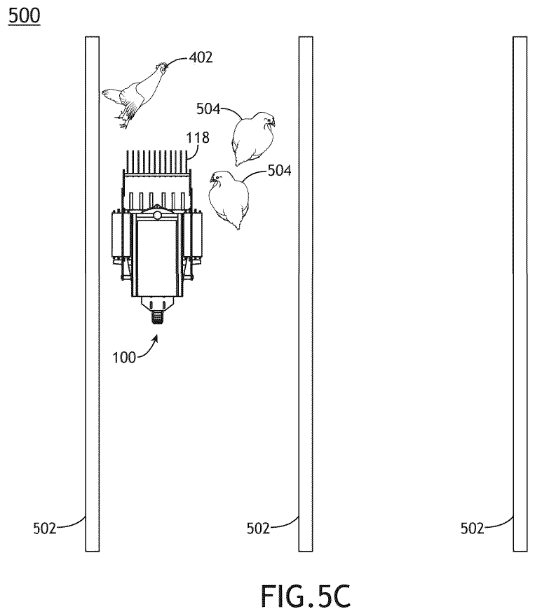

Referring generally to FIGS. 5A-5C, a navigation system 500 is described, in accordance with one or more embodiments of the present disclosure. The navigation system 500 may include one or more navigation devices 100, expired poultry 402, delivery lines 502, and live poultry 504. A poultry barn may include one or more the delivery lines 502, such as, feed lines (also known as feeder lines, feed delivery systems, and the like) and water lines (also known as drinker lines, water delivery systems, and the like). The delivery lines 502 may be hung from a ceiling of the poultry house. During the life cycle of the poultry, the delivery lines 502 may be raised from a ground surface for accommodating a beak height of the live poultry 504. Thus, the delivery lines 502 may be adjustable between a range of heights, including, but not limited to, four inches and forty-eight inches. The height of the feed line pipe and the water line pipe may be based on an age of the poultry and a breed of the poultry. For example, the height of the delivery line 502 may be lower for broiler chickens (as compared to turkeys, breeders, layers, or ducks), such as, but not limited to between four and twenty-four inches for such broilers. In embodiments, one or more of the camera 124 or the camera 126 is posed to capture the delivery lines 502 between the various ranges of heights as the height of the delivery line is adjusted to accommodate the poultry. The processors 202 of the navigation device 100 may then detect the delivery lines 502 within the images and engage the drive wheels 104 to avoid the delivery lines 502 by an obstacle avoidance protocol, or the like. In some instances, the delivery lines 502 may function as linear guides which the navigation device 100 may follow when navigating the barn. For example, the processors 202 may use the detected delivery lines 502 in combination with a known pose of the navigation device 100 within the environment for autonomous pathfinding.

As previously described, the navigation device 100 may be configured to provide one or more control signals to the one or more poultry avoidance sub-systems, such as a spinner assembly 120, such that the flexible members 122 cause the live poultry 504 to evacuate a forward path of the navigation device 100. For example, as shown in FIG. 5A, the navigation device 100 may be placed within a poultry environment having one or more live poultry 504 and one or more expired poultry 402. The navigation device 100 may travel within the barn for detecting expired poultry laying on the ground surface. Upon approaching the live poultry 504, the one or more processors 202 may detect the live poultry 504 (e.g., within an image stream from the camera 124, the camera 126, etc.). Upon detecting the live poultry 504, the processors 202 may also provide one or more control signals to the one or more poultry avoidance sub-systems to engage the spinner assembly 120 for rotating the flexible members 122. The flexible members 122 may then cause the live poultry 504 to evacuate the forward path, as shown in FIG. 5B. The processors 202 may then fail to detect the live poultry in the forward path, indicating the live poultry 504 has evacuated the forward path. When the processors 202 fail to detect the live poultry in the forward path, the spinner assembly 120 may be disengaged. By selectively engaging and disengaging the spinner assembly 120, a power consumption of the navigation device 100 may be reduced thereby improving a battery life. It is noted that, for purposes of the present disclosure, the terms “debird” and “debirding” may refer generally to one or more steps or sub-steps of a method of causing one or more live poultry to evacuate an area within the poultry environment.

Referring now to FIG. 5C, upon approaching the expired poultry 402, the one or more processors 202 may detect the expired poultry 402 (e.g., within the image stream from the camera 124, the camera 126, etc.). Upon detecting the expired poultry 402, the processors 202 may initiate one or more protocols, such as the method 300. In this regard, the navigation device 100 may retract the spinner assembly 120 and deploy the linkage mechanism including the grapple member 116 and the lift member 112. The navigation device 100 may then convey the expired poultry 402 to the container 108.

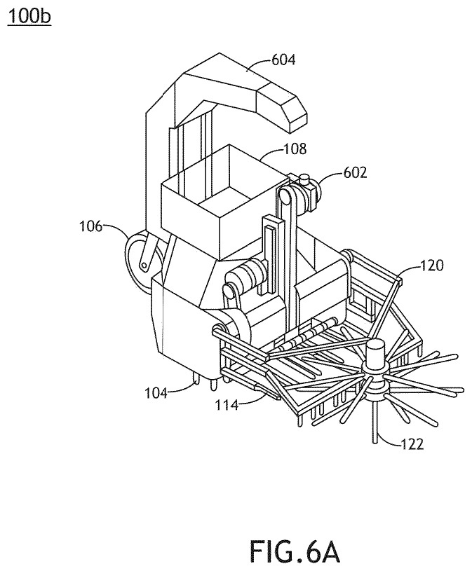

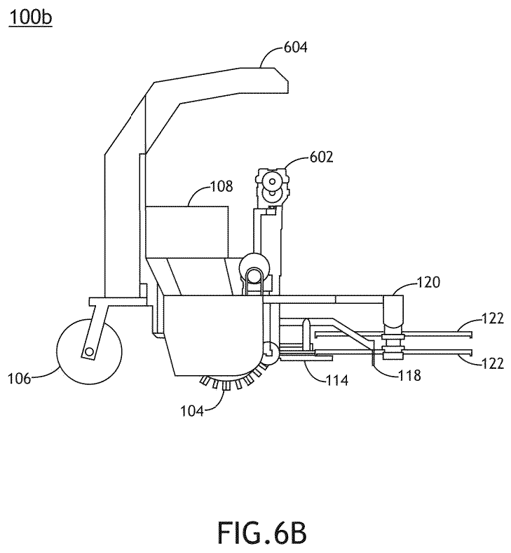

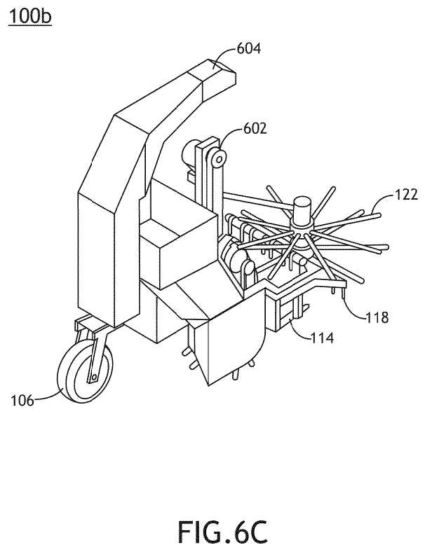

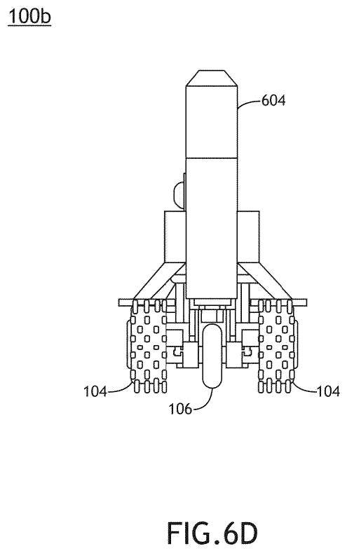

Referring generally to FIGS. 6A-6D, a navigation device 100b is described, in accordance with one or more embodiments of the present disclosure. Although the navigation device 100 has been described as including the lift member 112, this is not intended as a limitation on the present disclosure. In embodiments, the navigation device 100b includes a poultry retrieval sub-system configured to engage with one or more expired poultry and recover them from a poultry environment. The poultry retrieval sub-system may include, but are not limited to, the platform 114 and one or more chain drives 602 (e.g., chain and gear drive, grapple, or the like) configured to lift the platform 114. The platform 114 may thus be configured to lift expired poultry and deposit the expired poultry into the container 108.

In embodiments, the navigation device 100b includes a housing arm 604 coupled to the chassis 102. One or more components of the navigation device 100b may be disposed within the housing arm 604, such as, but not limited to, one or more cameras, controllers, or lights.

Referring generally again to FIGS. 1A-6D, although the navigation device 100 is described as including the spinner assembly 120, this is not intended as a limitation of the present disclosure. It is contemplated that the navigation device 100 may include alternative deterrent components for deterring live poultry from the forward path. For example, the deterrent components may include a contact deterrent, such as a push bar. By way of another example, the deterrent components may include a non-contact deterrent, such as, but not limited to, a light-based deterrent (e.g., a stroboscope, a laser, etc.), or a sound-based deterrent.

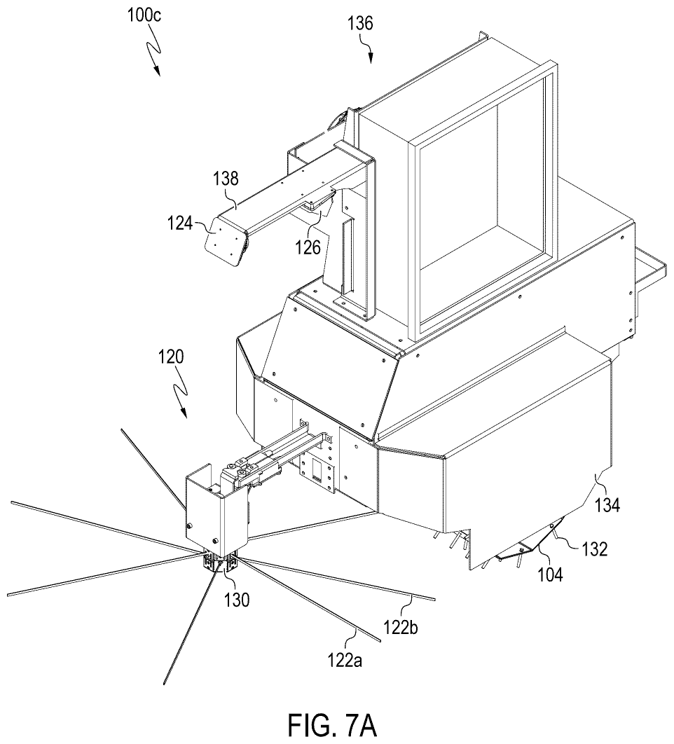

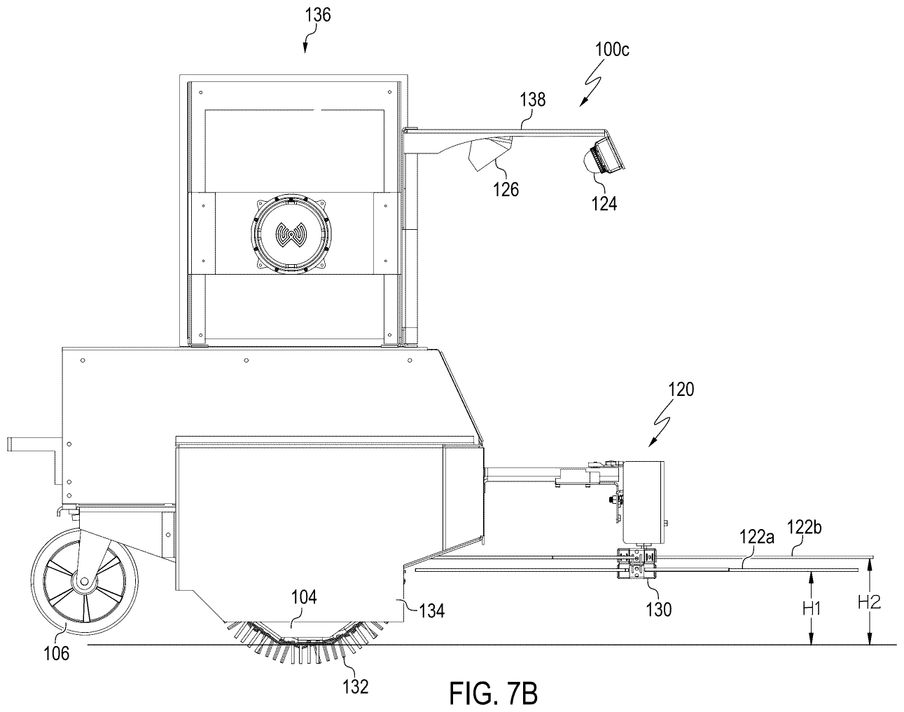

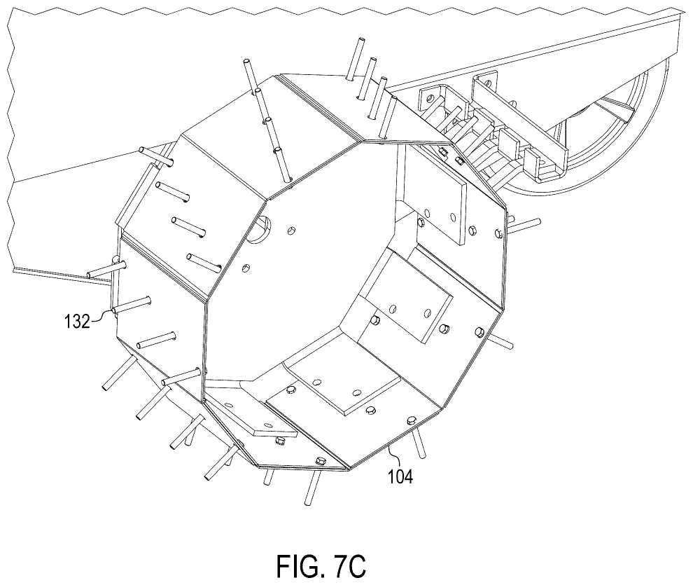

FIGS. 7A and 7B illustrate another embodiment of a vehicle or navigation device 100c for interacting with or moving animals. The navigation device 100c may include a spinner assembly 120 for encouraging movement of the animals in the movement path of or otherwise near the navigation device 100c. As best shown in FIG. 7B, the flexible members 122 of the spinner assembly 120 may be located at differing heights from the ground surface. For example, a first set of flexible members 122a may be located a first distance H1 from the ground and a second set of flexible members 122b may be located a second distance H2 from the ground. The first distance H1 may be between about 3 inches and 15 inches from the ground in one embodiment for use with poultry as an example, between about 4 inches and 11 inches in another embodiment, and between about 5 inches and 7 inches in a further embodiment. The second distance H2 may be between about 4 inches and 20 inches from the ground in one embodiment for use with poultry as an example, between about 5 inches and 14 inches in another embodiment, and between about 6 inches and 8 inches in a further embodiment. The second distance H2 may be about 1 inch to 10 inches greater than the first distance H1, between about 1 inch and 6 inches greater than the first distance H1 in another embodiment, and between about 1 inch and 3 inches greater than the first distance H1 in a further embodiment. Additional sets of flexible members 122 may be added and located at additionally distinct distances from the ground. This arrangement can help ensure the flexible members 122 contact animals of varying heights and/or at various height positions on the body of the animal, which may be more likely to encourage animal movement as desired.

Each set of flexible members 122a, 122b may have the same number of flexible members 122 and the flexible members 122 may extend from and be evenly spaced about a central hub 130 of the spinner assembly 120. For example, as shown in FIG. 7A, the first set of flexible members 122a may include four flexible members 122 spaced at 90° intervals about the central hub 130. Further the second set of flexible members 122b may include four flexible members 122 spaced at 90° intervals and offset from the flexible members 122 of the first set of flexible members 122a by 45°. This arrangement can reduce the gaps between the flexible members 122 in the spinner assembly 120. The position of the spinner assembly 120 relative to the navigation device 100c, position of the flexible members 122 relative to the ground, and number of flexible members 122 may be specifically selected or optimized to balance healthy animal movement and reduced animal stress. Likewise, the material type, stiffness, size, and length of the flexible members 122 may be optimized for healthy animal movement and reduced animal stress.

FIGS. 7A and 7B illustrate that the navigation device 100c may include two drive wheels 104 and a caster wheel 106. The drive wheels 104 may include a spiked tread (e.g., a tread with rods integrated into one or more portions of the wheels, where the rods may be configured to provide traction, till, and/or break up debris or other material disposed within a poultry environment). As shown in FIG. 7C, rods 132 may extend outward from the traction surface of the drive wheel 104 to provide the spiked tread. As shown, the rods 132 may be staggered or offset such that each rod 132 of a drive wheel 104 is begins to enter and exit the ground at a different time than the other rods 132. This arrangement can provide a smoother and more continuous traction control and tilling service than if a group of rods 132 were placed in a horizontal row across the drive wheel 104. In other embodiments, different numbers of drive wheels 104 and/or caster wheels 106 may be utilized, or other traction configurations may be provided, such as using continuous tracks (e.g., chain tracks) instead of wheels.

As shown in FIGS. 7A and 7B, the navigation device 100c may include a fender or skirt 134 that at least partially covers the drive wheels 104 and caster wheel 106. The skirt 134 may extend close enough to the ground to protect animals from getting caught under the navigation device 100c or otherwise being harmed by the moving navigation device 100c (e.g., the skirt 134 may simply push an animal instead of trapping the animal). The skirt 134 may also have sufficient clearance from the ground to enable the navigation device 100c to navigate uneven or inconsistent terrain of the environment without the skirt 134 digging into or plowing through the terrain or otherwise getting stuck on the terrain. For example, the bottom portion of the skirt 134 may be located approximately 1-3 inches from the ground surface when the navigation device 100c is on level ground.

The navigation device 100c may be powered by a rechargeable battery (not shown). In some embodiments, the navigation device 100c dock itself at a charging port to recharge when its battery is low. In some embodiments, the navigation device may use a rechargeable battery that can easily and efficiently be swapped out by a user, and removed rechargeable battery is placed on a charging station to recharge while the navigation device 100c continues working. In some embodiments, the navigation device 100c may include a solar panel to supplement the battery power or even recharge the rechargeable batter to reduce the frequency of recharging or battery swaps. In some embodiments, the navigation device may be powered by a fuel cell or a hybrid power system that combines multiple power sources (e.g., battery and gasoline engine powered hybrid system).

The navigation device 100c may include the processors, controllers, and other sensitive electronic equipment in an easily removable enclosure. This removable enclosure may be located in an ideal location for a technician or operator to easily access, maintain, clean, upgrade, repair and change settings on the electronic equipment. As shown in FIG. 7B, the removable enclosure 136 may be located at an upper portion of the chassis 102.

In some embodiments, the navigation device 100c may include a housing arm 138 coupled to the chassis 102. One or more components of the navigation device 100c may be disposed on the housing arm 138, such as, but not limited to, one or more cameras or other sensor units, controllers, or lights. For example, as shown in FIGS. 7A and 7B, a first camera 124 may be located on an outward end of the housing arm 138 away from the chassis 102 and directed back towards the chassis 102 and spinner assembly 120 of the navigation device 100c. A second camera 126 may be located on the housing arm 138 proximate to the chassis 102 and may be directed towards the forward path of the navigation device 100c. Thus, the first camera 124 can better detect animals or other obstacles immediately proximate the navigation device 100c and the second camera 126 can better detect animals in the forward path of the navigation device 100c or generally farther away from the navigation device 100c. Additional cameras or other sensor units may be included on the housing arm 138 or on other portions of the navigation device 100c.

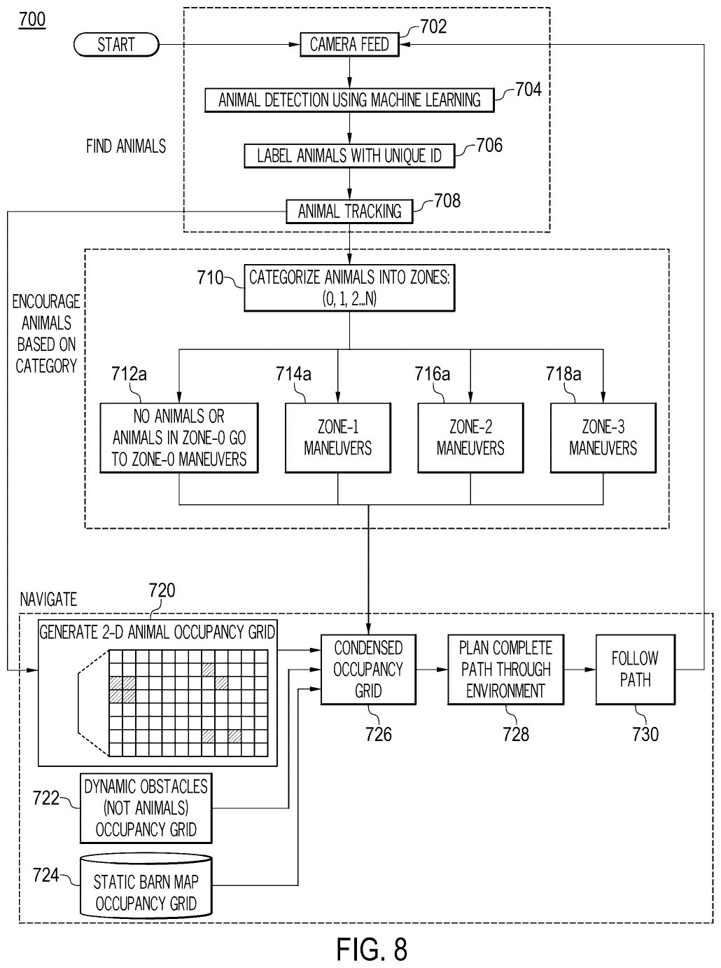

Referring now to FIG. 8, a simplified block diagram of an automated navigation system 700 for a navigation device, such as navigation device 100c is shown. Sensors and cameras' raw inputs 702 (e.g., from cameras 124, 126, 128 and LiDAR 214 and other sensor units) may be used to detect animal location 704 using a specialized machine learning algorithm. Each detected animal be labeled with a unique animal identification 706 to assist in animal tracking 708. Aside from assisting the navigation device 100c in navigating the environment, animal identification 706 and animal tracking 708 may be used to record historical information about the animals, such as size, age, health characteristics, and the like, which can be used by operators to better manage the animals' health and keep records of animal productivity.

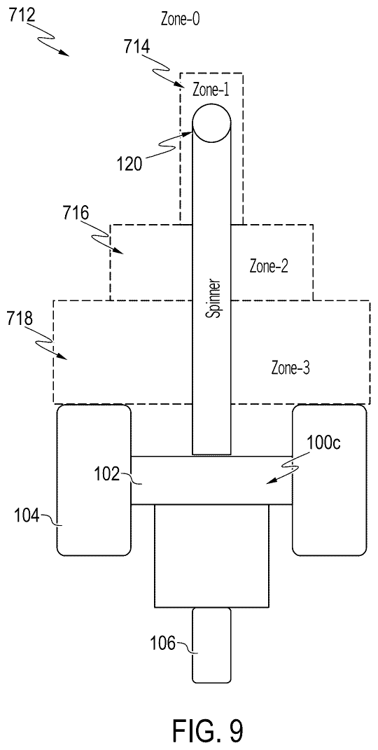

The animal tracking 708 may be used to categorize the animals into zones 710. For example, as shown, the animals can be categorized into a “Zone-0” 712, a “Zone-1” 714, “Zone-2” 716, and “Zone-3” 718 (see FIG. 9) based on an animal's relative location or position to the navigation device 100c and spinner assembly 120. Based on which zone the animal is categorized in, the navigation device 100c and spinner assembly 120 can be controlled for specific movements to ensure animals are not harmed and encouraged to move from the path of the navigation device 100c. The animal tracking 708 may also be used to generate a 2-D animal occupancy grid 720 of the animals in the environment. Another 2-D map may be generated of non-animal (or animals other than the desired animal) obstacles within the environment 722 and overlaid with a static barn map 724 in addition to the animal occupancy grid 720 to create a condensed occupancy grid and map 726. This condensed occupancy grid and map 726 may be used to plan a global path through the animal environment 728 depending on the mode navigation system is selected for (e.g., to encourage animal movement, environmental cleaning, specific animal tracking, etc.). The navigation device 100c is then controlled to follow the planned path through the environment 730 while iteratively following the steps of the automated navigation system 700.

FIG. 9 illustrates a schematic example of zones an animal may be categorized into according to categorization process 710. Zone-0 712 may broadly encompass the region of the environment that is not near the navigation device 100c and its forward path. Zone-1 714 may be region immediately in front of the navigation device 100c and its forward path and in a location where the spinner assembly 120 may reach or nearly reach an animal located. Zone-2 716 may be a region closer still to the navigation device 100c and Zone-3 718 is a region where an animal is at risk of harm from further forward movement of the navigation device 100c. The size of these zones and their distance from the chassis 102, drive wheels 104, and spinner assembly 120 of the navigation device 100c may vary depending on the animal type and/or the speed or operating purpose of the navigation device 100c. In general, the zones and portion of a single zone further away from the navigation device 100c may be narrower than the zones and portion of a single zone nearest the navigation device 100c. For example, in some embodiments, Zone-1 714 may be “tapered” or “angled” such that Zone-1 714 is wider at its point nearest the navigation device 100c and narrowest at its point farthest from the navigation device 100c.

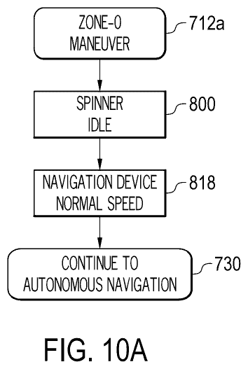

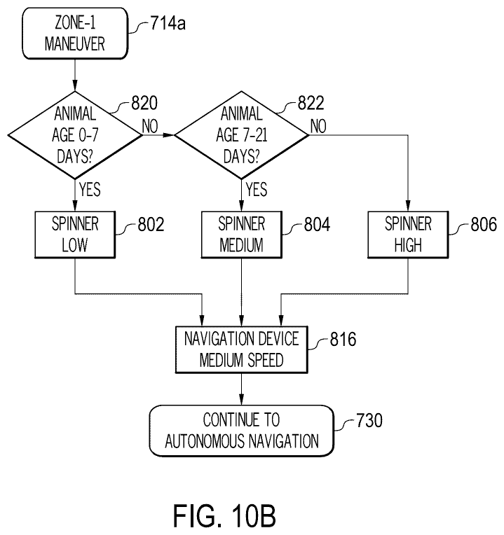

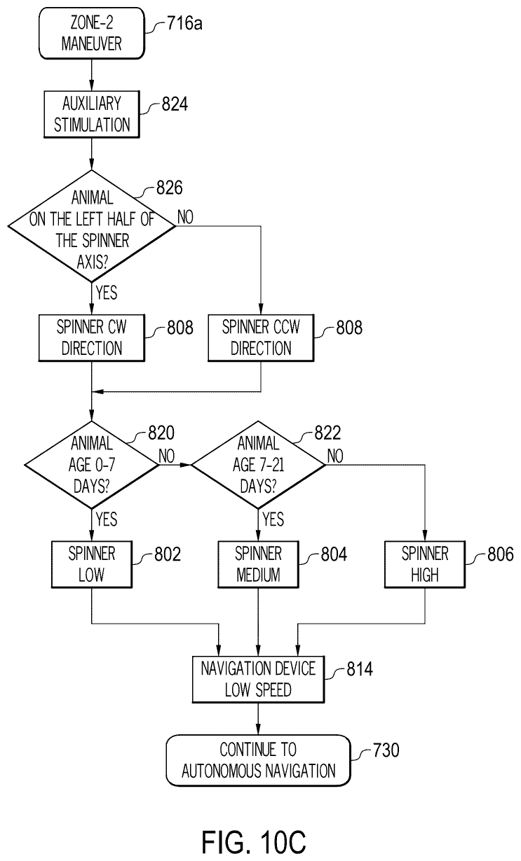

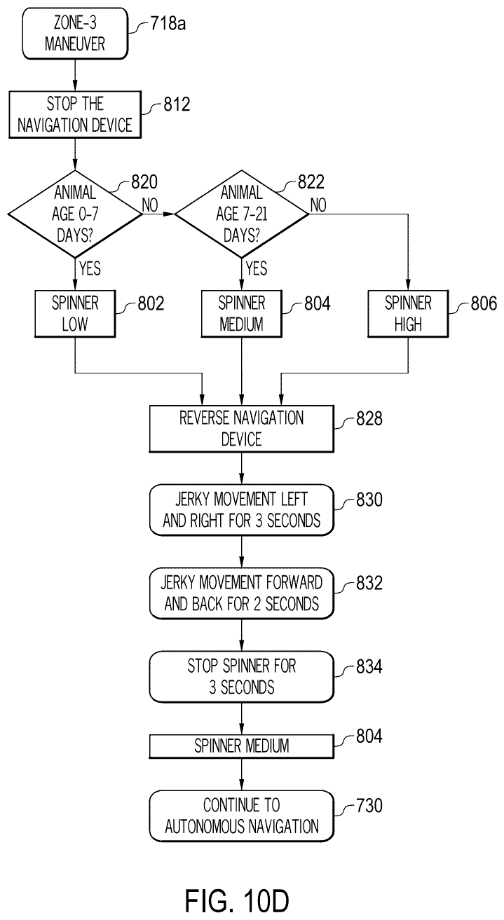

Various maneuvers may be employed by the navigation device 100c and spinner assembly 120 to encourage animal movement when an animal occupies a zone near the navigation device 100c. For example, FIGS. 10A-10D illustrate various maneuvers that may be employed depending on which zones an animal occupies. When animals are detected in different zones, the navigation device 100c operates according to the maneuver of the zone nearest the navigation device 100c (e.g., if an animal is detected in Zone-1 714 and Zone-3 718, the navigation device 100c operates based on a Zone-3 maneuver). Depending on the maneuver, the spinner assembly 120 may be set to an idling setting 800, low speed 802, medium speed 804, or high speed 806. These speed settings can be optimized depending on the type of animal and determined in terms of rotations per minute (RPM) of the flexible members 122 of the spinner assembly 120. For example, for poultry, low speed 802 may be set to a specific predetermined number of RPMs, medium speed 804 may be set to a speed that is approximately twice as many RPMs as low speed 802, and high speed 806 may be set to a speed that is approximately three times as many RPMs as low speed 802. Depending on the animal type and operation of the navigation device 100c, the idling setting 800 may correspond to low speed 802, medium speed 804, or some other speed entirely. In some instances, to conserve energy, the idling setting 800 may turn the spinner assembly 120 off entirely. The spinner assembly 120 may also be set to spin in either a clockwise direction 808 or a counterclockwise direction 810 (i.e., when viewed from above the spinner assembly 120) depending on the maneuver and location of the animals. Additionally, the speed of the navigation device 100c may be set to stop moving 812, low speed 814, medium speed 816, or high or normal speed 818. Other features of the spinner assembly 120 and navigation device 100c may be selectively controlled in various maneuvers as further described below.

As shown in FIG. 10A, when an animal is detected in Zone-0 712 (or no animal is detected), the Zone-0 maneuver 712a may set the speed of the spinner assembly 120 to its idling setting 800 and the navigation device 100c to its normal operating speed 818 to follow its autonomous path through the environment 730.

As shown in FIG. 10B, when an animal is detected in Zone-1 714, the Zone-1 maneuver 714a may first detect an animal's size and/or age. For example, the cameras and algorithm may first detect if the animal is “young” or “small” (e.g., 0-7 days old for poultry, as shown) in the first age/size detection step 820. If so, the spinner assembly 120 may be set to its low speed 802. If the animal is not detected to be young or small in the first age/size detection step 820, then a second age/size detection step 822 may determine if the animal is “medium aged” or “medium” size (e.g., 7-21 days old for poultry, as shown). If the animal is a medium age or size, the spinner assembly 120 may be set to its medium speed 804. If the animal is not detected to be a medium age or size (i.e., mature age or large sized), the spinner assembly 120 may be set to its high speed 806. As shown in FIG. 10B, the navigation device 100c may operate at its medium speed 816 to follow its autonomous path through the environment 730 regardless of the animal size/age. In other embodiments, the speed of the navigation device 100c may also be altered depending on the size/age of the animal in Zone-1 714.

As shown in FIG. 10C, when an animal is detected in Zone-2 716, the Zone-2 maneuver 716a may apply auxiliary stimulation 824 directed at the animal. Auxiliary stimulation 824 may include audio and/or light stimulation directed at the animal to encourage it to move. Audio stimulation may be varied in the type and volume of sounds used. Light simulation may use various types, patterns, and intensity of lights and lasers. Auxiliary stimulation 824 may also include blowing air with a fan or compressed air supply at the animal to encourage its movement. Further, auxiliary stimulation may include additional mechanical devices to interact with the animals besides the spinner assembly 120.

With continued reference to FIG. 10C, the Zone-2 maneuver 716a may perform a side detection 826 to determine whether the animal is on the left or right half of spinner assembly 120. If the animal is on the left side of the spinner assembly 120, the spinner assembly 120 may be set to spin in a clockwise direction 808. If the animal is on the right side of the spinner assembly 120, the spinner assembly 120 may be set to spin in a counterclockwise direction 810. These spinner directions can better encourage an animal to move away from the navigation device 100c. Similar to the Zone-1 maneuver 714a, the Zone-2 maneuver 716a may use first and second age/size detection steps 820, 822 to determine if an animal is young/small, medium, or mature/large and may set the spinner assembly 120 to low speed 802, medium speed 804, or high speed 806 based on that determination as shown in FIG. 10C. As shown in FIG. 10C, the navigation device 100c may operate at its low speed 814 to follow its autonomous path through the environment 730 regardless of the animal size/age. In other embodiments, the speed of the navigation device 100c may also be altered depending on the size/age of the animal in Zone-2 716.

As shown in FIG. 10D, when an animal is detected in Zone-3 718, the Zone-3 maneuver 718a may bring the navigation device 100c to a stop 812 to avoid potential harm to the animal. Similar to the Zone-1 maneuver 714a, the Zone-3 maneuver 718a may use first and second age/size detection steps 820, 822 to determine if an animal is young/small, medium, or mature/large and may set the spinner assembly 120 to low speed 802, medium speed 804, or high speed 806 based on that determination as shown in FIG. 10D. The navigation device 100c may then reverse 828 at a slow speed. The navigation device 100c may then make a side-to-side jerky motion 830 for a period (e.g., for three seconds). This side-to-side jerky motion 830 may be accomplished using the zero-degree turning radius capability of the navigation device 100c by having a first drive wheel operate in the forward direction and a second drive wheel operating in the reverse direction. The navigation device 100c may them make a forward and back jerky motion 832 for a period of time (e.g., two seconds). The forward and back jerky motion may be accomplished without the navigation device 100c moving a substantial distance forward or backwards. The spinner assembly 120 may then be turned off 834 for a period of time (e.g., three seconds). The spinner assembly 120 may then be set to medium speed 804 and the navigation device 100c may operate at its low speed 814 to follow its autonomous path through the environment 730.

If an animal remains in Zone-3 718 after a Zone-3 maneuver 718a, the Zone-3 maneuver 718a may be repeated as part of the navigation system 700. Alternatively, the navigation system 700 may alter its planned global path 628 to circumnavigate the animal.

In other embodiments, additional or fewer zones may be used by the navigation system 700 and additional or fewer steps may be taken in each zone maneuver. The navigation system 700 may be utilized for a variety of purposes, including to encourage healthy movement of the animals in the environment while reducing stress and harm to the animals. In some embodiments, it may be desirable for the navigation device 100c to approach a given animal at a specific speed or angle to encourage that animal's movement.

Navigation system 700 is described in connection with dynamically altering the spinner assembly 120. In other embodiments, navigation system 700 may be utilized with other types of animal movement encouragement devices, which may have low, medium, and high intensity settings similar to as described for the spinner assembly 120.

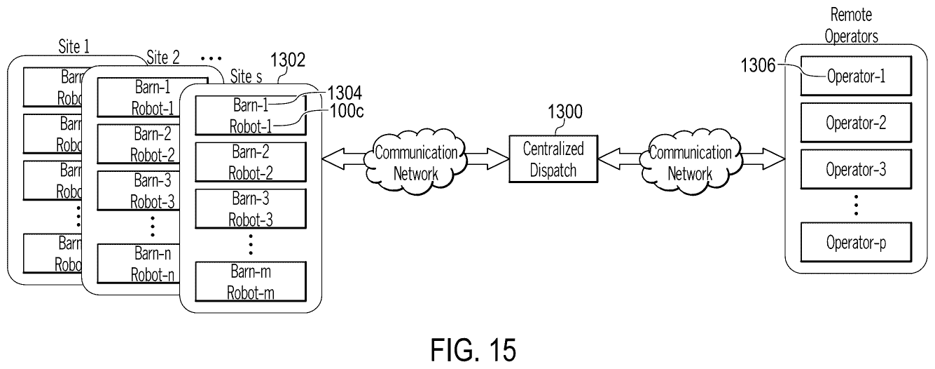

An automated navigation system, such as automated navigation system 700, may be used to control movement of a navigation device, such as navigation device 100c, to have the navigation device achieve specific objectives or goals or perform specific tasks. For example, the navigation device 100c may be controlled to navigate the barn or environment to encourage feeding (e.g., by directing animals toward food sources), to perform pesticide and anti-bacterial spraying of the environment (and/or animals), to redistribute the animals for crowd management (e.g., reduce overcrowding in certain areas by dispersing animals in those areas), or to improve the sensor coverage and data collection of the animals and the environment. The navigation device 100c may include one or more ambient condition sensors, such as, but not limited to, a temperature sensor, a humidity sensor, an air quality sensor (e.g., a carbon dioxide sensor, an oxygen sensor, a nitrogen sensor, etc.), and the like. Among other things, the navigation device 100c may be used to measure, monitor, and/or log certain aspects of the environment such as temperature, humidity, air speed, barometric pressure, dew point, ammonia, carbon monoxide, air quality, air chemistry, bedding moisture, bedding quality, drinking water availability, feeder availability, HVAC operations, lighting intensity and timing. In some instances, the navigation device 100c may communicate directly with other systems to manage the environment, such as communicating temperature irregularities to the HVAC system. In some instances, the navigation device 100c may directly manage the environment such as by increasing tilling in an area where poor bedding quality is detected. In some instances, the navigation device 100c may communicate with a remote workstation, operator, or centralized dispatch system that may then address any issues or irregularities as desired (see FIG. 15).

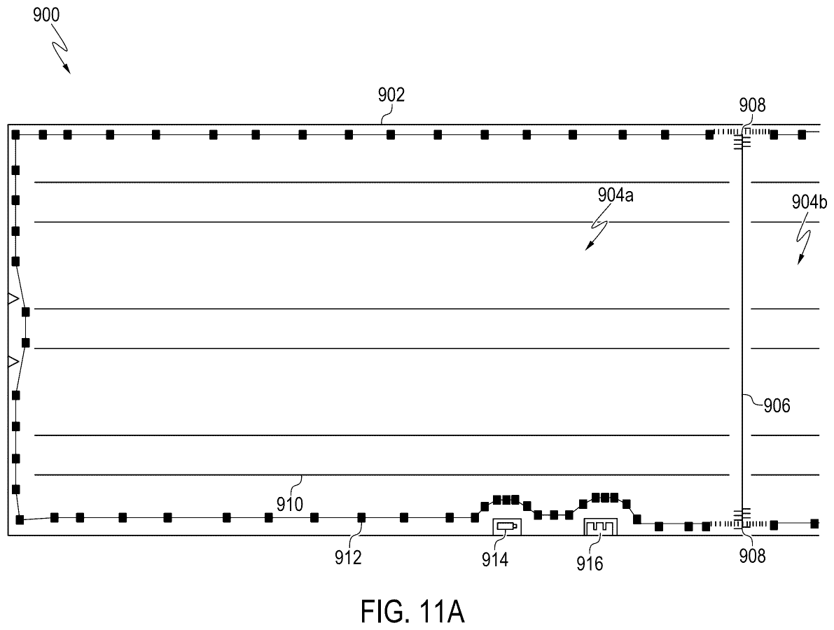

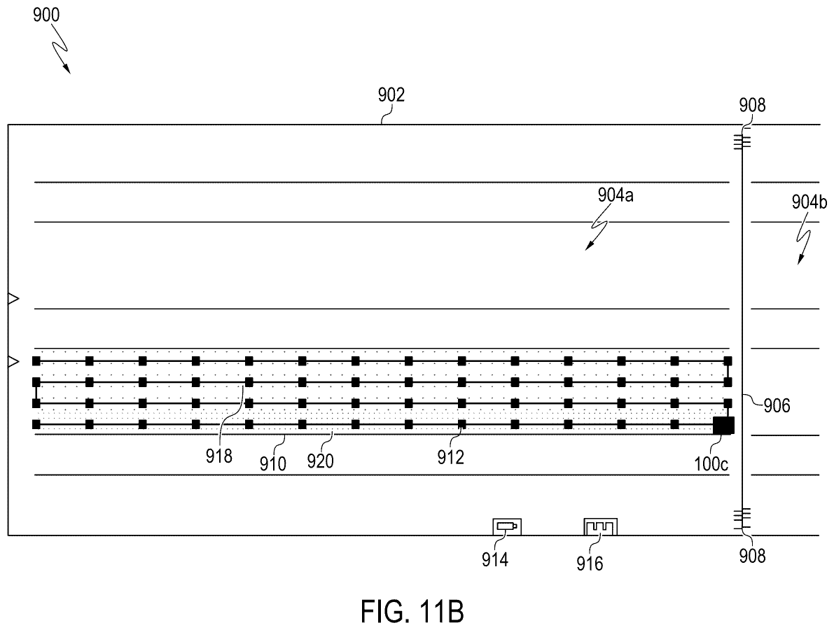

FIG. 11A illustrates a portion of a schematic barn environment mapping 900 that may be used by a navigation device 100c to autonomously navigate the barn environment. The mapping 900 shows a barn 902 that is divided into multiple rooms or sections 904a, 904b as separated by walls 906 or other obstacles that prevent movement of the animals between the sections 904. The walls may include gates 908 for the navigation device 100c and personnel to move between sections 904. Sections 904 may include row obstacles 910 (e.g., feed and drink trough systems) or other obstacles that the navigation device 100c must navigate around when moving through the environment. The navigation device 100c may generate waypoints 912 for its path through the environment depending on its objective or task. For example, FIG. 11 illustrates waypoints 912 for a lap or path adjacent the perimeter of the barn 902, which can be done to encourage animals toward the interior areas to encourage eating or drinking or for other purposes. The navigation device 100c attempts to move in a straight line between adjacent waypoints 912 to achieve its path and objective (subject to other inputs and navigation controls, such as automated navigation system 700 to avoid colliding with an animal). As shown, the waypoints 912 may be generated to create a generally straight line path where possible and to avoid obstacles that otherwise cross that path, such as to avoid the charging station 914 and fluid refill station 916.

FIG. 11B illustrates a mapping 900a with waypoints 912 that may be used for the navigation device 100c to perform spraying of a pesticide or anti-bacterial fluid on a target treatment area 918. The navigation device 100c may be equipped with a fluid storage tank or reservoir and one or more spray nozzles for dispensing the fluid. The waypoints 912 may be generated to provide offset “strips” or paths for the spray coverage of the navigation device 100c. The mapping 900a may be updated to show the treated area 920 as the navigation device 100c moves along the path. During other objectives of the navigation device 100c, the treated area 920 may be mapped to indicate other treatments, such as ground tilling.

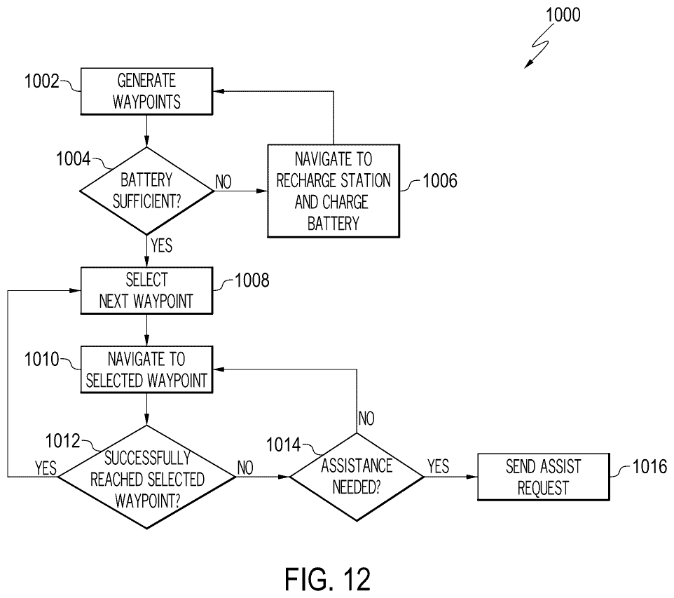

As shown in FIG. 12, the navigation device 100c may perform autonomous navigation 1000 (which may be similar to path planning 728 and path following 730 in FIG. 8). The autonomous navigation 1000 generates waypoints 1002 for a path according to a desired objective or task of the navigation device 101c (e.g., path for a lap (see FIG. 11A), path for back-and-forth row monitoring, etc.). The battery charge level may be checked 1004 to determine if the battery is sufficiently charged to perform the task (or at least a sufficient portion of the task if the task takes multiple laps or passes through the environment). If not, the navigation device 100c may be directed to navigate to the recharge station 914 to dock and charge the battery 1006 (generating a new set of waypoints 912 and following those waypoints 912 to the recharge station). Once the battery is sufficiently recharged, and using a possibly newly generated set of waypoints 1002, the autonomous navigation 1000 selects the next waypoint in the path 1008. The navigation device 100c moves to the selected waypoint 1010 in a generally straight path (accounting for any newly detected obstacles or other subprocesses or maneuvers). The autonomous navigation 1000 detects whether the navigation device 100c has successfully reached the selected waypoint 1012. If it has, it selects the next waypoint in the path 1008 and iterates the process to follow the path. If the navigation device 100c has not reached the selected waypoint, the autonomous navigation 1000 determines if assistance is needed 1014. For example, if the amount of time spent navigating between the waypoints has exceeded a threshold time, the autonomous navigation 1000 may indicate there is an error and send a request for assistance 1016 to an operator or dispatch. If it is determined that assistance is not needed, the navigation device 100c may continue navigating to the selected waypoint 1010.

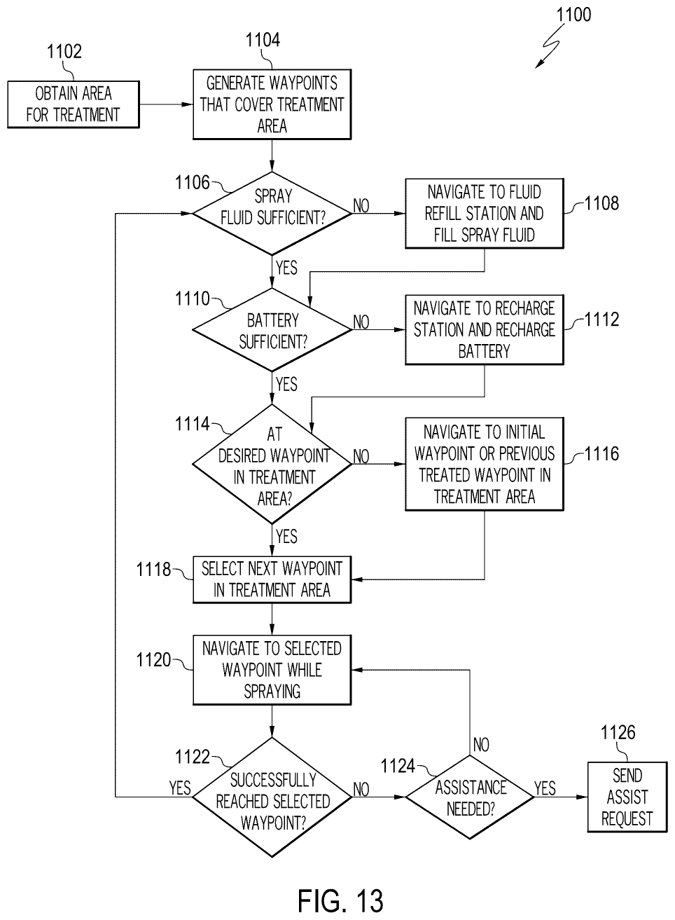

As shown in FIG. 13, autonomous navigation 1100 may require additional steps to perform certain tasks, such as spraying pesticide or other fluid treatment. When the navigation device 100c is selected to spray or treat an area, the autonomous navigation 1100 may first obtain a specific area of the barn to be treated 1102 (which may be an entire section 904, the entire barn 902, entire rows or aisles between row obstacles 910, or portions of any of the forgoing). The autonomous navigation 1100 may then generate waypoints that effectively cover the treatment area 1104. Generating the waypoints to cover the treatment area 1104 can account for the width of a spray or treatment. In some embodiments, the spray may be applied approximately equal to the width of the navigation device 100c, in which case the waypoints of adjacent path segments can be offset by approximately the width of the navigation device 100c. In some instances, the spray or treatment may be applied in a width that differs from the width of the navigation device 100c or may be applied such that it is offset from the center of the navigation device 100c. In such cases, the offset of waypoints of adjacent path segments may be adjusted accordingly.

The amount of spray fluid available on the navigation device 100c may be measured to determine if the amount of spray fluid is sufficient 1106. If not, the navigation device 100c may be directed to the refill station 916 to fill the spray fluid to a sufficient level 1108. Likewise, the battery charge level may be checked 1110 to determine if the battery is sufficiently charged. If not, the navigation device 100c may be directed to navigate to the recharge station 914 to dock and charge the battery 1112 to a sufficient level. In both the instance of the spray fluid and the battery charge level, a “sufficient” amount of fluid or charge may be variable depending on the expected length of the task, the rate at which the task depletes the fluid or charge, the location of the navigation device 100c relative to the refill station 916 or recharge station 914, and other factors that can provide more efficient operation and task performance. For example, if the battery charge is not yet at a low threshold level that would normally call for charging but the autonomous navigation device 100c is near the recharge station 914 and would otherwise be navigating away from the recharge station 914, the battery charge may be considered “insufficient” such that the battery is charged earlier than it might otherwise be directed to charge in a different scenario. As another example, the measure of the spray fluid sufficiency 1106 may vary if the navigation device 100c is already being directed to the recharge station 914 and the refill station 916 is located near the recharge station 914 (as is the case in example shown in FIG. 11A). In such a case, the navigation device 100c may be directed to refill fluid 1108 so as to avoid an additional trip to the “base area” of the recharge station 914 and refill station 916.

If the battery and spray fluid levels are sufficient, the autonomous navigation 1100 determines whether the navigation device 100c is at the desired waypoint to perform the spraying or treatment 1114. If not, as for example, if the navigation device 100c navigated away from the treatment area to the recharge station 914, then the navigation device 100c is directed to navigate to waypoint where treatment last occurred 1116 or the initial waypoint if no treatment has occurred yet (using, for example, autonomous navigation 1000 to reach this specific waypoint). If the navigation device 100c is at the desired waypoint to perform the spraying or treatment, then the next waypoint in the treatment path is selected 1118. The navigation device 100c then moves to the selected waypoint while spraying the fluid 1120. If it is determined that the selected waypoint is successfully reached and spraying was performed adequately 1122, then the area between these waypoints is marked as treated and the process is repeated to select the next waypoint and continue treating the selected area. If the next waypoint is not successfully reached as expected, the autonomous navigation 1100 may determine if assistance is needed 1124, and if so, may send an assist request 1126.

As shown in FIG. 11A, the navigation device 100c may need to navigate from a first section 904a to a second section 904b of the barn 902. The barn 902 may be equipped with gates 908 that permit the navigation device 100c to pass through the gate 908 while preventing birds from passing through the gate 908, which can ensure animals do not migrate between sections 904 and a balanced or desired distribution in each section can be maintained. The gate 908 may have an opening that is covered by a curtain of flexible material (e.g., plastic or rubber) that allow the navigation device 100c to push through the gate 908. The flexible material may be sufficiently heavy to prevent the animals from being able to push through the gate 908.

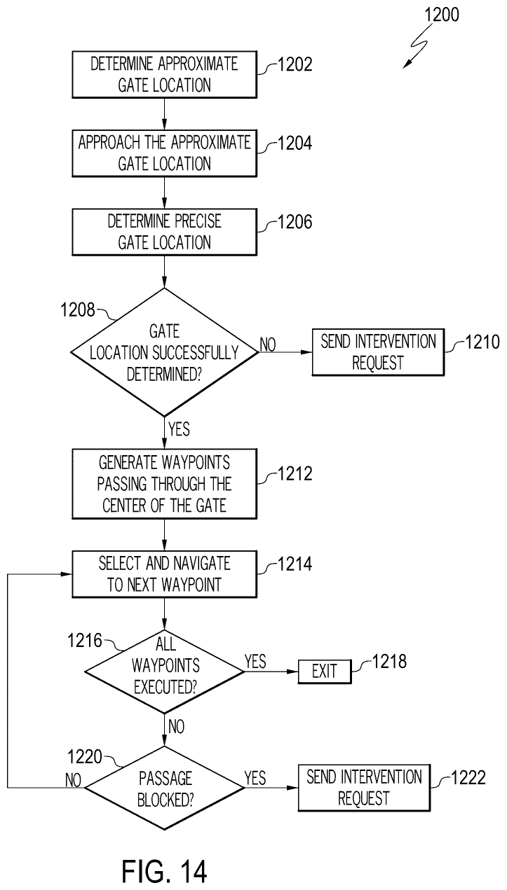

FIG. 14 illustrates a gate crossing method 1200 for the navigation device 100c. The gate crossing method 1200 may determine the approximate location of the gate 1202 relative to the navigation device 100c by using the known position of the gate 908 in the barn 902 (i.e., as input in a static global mapping of the barn 902) and the detected position of the navigation device 100c within the barn 902, by using sensors, including visual sensors and LiDAR, to detect the gate 908, or a combination of known positioning and sensor detection of the gate 908. Next, the navigation device 100c may approach the approximate gate location 1204. At a position directly in front of the gate 908, the navigation device 100c may determine the precise gate location 1206. The precise pose (position and orientation) of the gate 908 may be determined using visual detection of the various features of the gate 908. Augmented reality (AR) tags or fiducial markers may be attached to the gate 908 at known positions to increase the accuracy of the pose measurement. The fiducial markers may be attached to the frame so that the pose of the opening of the gate 908 can be accurately determined regardless of the current position of the flexible curtain. For example, a fiducial marker may be placed at the center of a top cross bar of the frame and on left and right side posts of the frame. Knowing the precising pose of the opening is also useful during the gate crossing method 1200 because the visual sensors and LiDAR may not be as effective when passing through and being partially blocked by the curtain material. In some instances, additional fiducial markers may be attached to the curtain to obtain additional information about the current position of the curtain relative to the frame of the gate 908. Each fiducial marker may be distinct and placed at a know position so that the detection of the fiducial marker is on a known gate and specific portion of the gate (e.g., fiducial marker A is on the left post of gate X, fiducial marker B is on the curtain of gate Y, etc.).

If it is determined that the pose of the gate accurately measured 1208, then the a series of waypoints may be generated that pass directly through the opening of the gate into the next section of the barn 1212. If the pose of the gate cannot be accurately determined, then an intervention request may be sent to an operator or central dispatch 1210. Once the waypoints are generated through the gate as part of step 1212, next waypoint may be selected and the navigation device 100c may navigate to that waypoint 1214. The method 1200 may then check if all waypoints have been reached or executed to determine if the gate crossing is complete 1216. If so, the gate crossing method 1200 may be exited 1218 and the navigation device 100c may resume its global path or other task. If not all waypoints have been executed, then it should be determined if the passage is obstructed or blocked 1220. If not, the method 1200 should keep selecting and navigating to the next waypoint 1214. If it is determined that the passage is blocked, such as visually or physically detecting an obstruction or by reaching a threshold time limit for crossing through the gate, an assist or intervention request may be sent to an operator or central dispatch 1222.

The navigation device 100c may wirelessly communicate with an operator or central dispatch. A human operator may be able to remotely see the status of the navigation device 100c. Human operators may also be alerted of any requests for assistance or intervention. In some instances, the remote operator may be able to address the issue remotely. For example, the human operator may remotely control the navigation device 100c to overcome an issue in certain instances. In some instances, the human operator may need to alert on-site personnel to physically intervene.

As shown in FIG. 15, multiple navigation devices 100c may all communicate with a centralized dispatch system 1300 that monitors and logs operations of all of the navigation devices 100c. The centralized dispatch system 1300 can monitor one or more locations or sites 1302, each of which may have personnel for serving that specific site 1302. Each site 1302 may include one or more barns 1304, and each barn may include a navigation device 100c. In some instances, multiple navigation devices 100c may operate in a single barn. Each navigation device 100c, barn 1304, and site 1302 may have a specific identification number or code, such communication from a given navigation device 100c is known to be in a specific barn 1304 at a specific site 1302. This identification system can help alert the correct on-site personnel of any issues or information related to one of the navigation devices 100c. The centralized dispatch system 1300 may communicate with one or more human operators 1306 that may be located remotely.

Any requests for assist or intervention from a navigation device 100c may be placed in a queue by the centralized dispatch system 1300. Remote operators may select an intervention/assist request (or be directly assigned requests). Each request may include information to indicate the site, barn, navigation device, and reason for the request. Each assist request may be assigned a priority value in the queue depending on the request type. Standard priority values may be provided in a table, but a user may alter the priority values for various request types depending on specific operation needs. For example, if a navigation device 100c is stopped due to a bump stop trigger, it may likely indicate that the navigation device 100c has contacted a hard surface, which receives a high priority value so that an operator 1306 (and possibly on-site personnel) intervene quickly and avoid additional possible damage to the navigation device 100c.

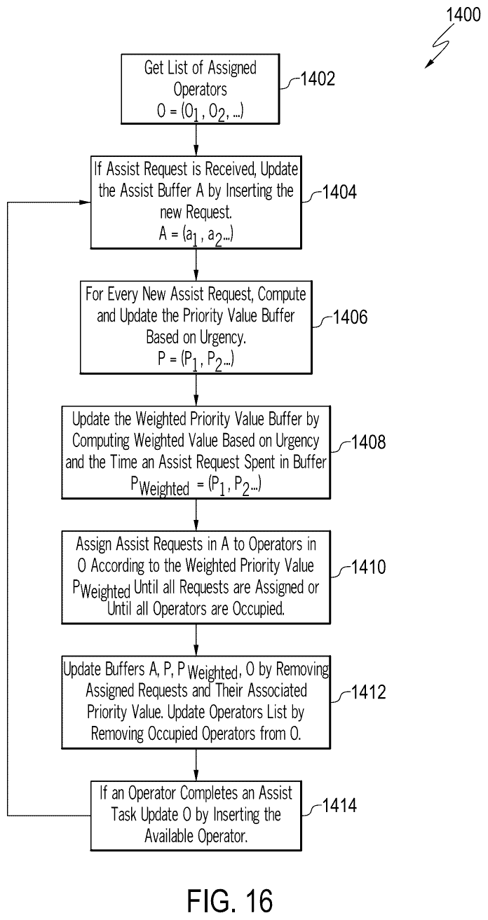

FIG. 16 illustrates an automated system 1400 for centralized dispatch 1300 to prioritize and assign intervention/assist requests. First, the automated system 1400 may obtain a list of operators 1306 that are logged on to the centralized dispatch 1300 and available 1402. When an assist request is received, the assist buffer or list of assist requests is updated by inserting the new request in the list 1404. Each new assist request may be assigned a priority value based on the urgency of the request type 1406. A weighted priority value of each outstanding assist request may be updated based on the original priority value and the time spent in the buffer or queue 1408. So a request that has spent a longer time in the queue will have its priority weighed higher. The outstanding assist requests may be ordered in the queue according to the weighted priority value, and assist requests may be assigned in order until all requests are assigned or until all available operators are occupied 1410. The buffers for assist requests and operators may be updated by removing assigned requests and their associated priority and weighted priority values, and the list of available operators may be updated by removing occupied operators from the list 1412. If an operator completes an assist request task, the operator may be added to the list of available operators 1414. An operator may complete an assist task by handling the assist task remotely or by alerting on-site personnel to handle the assist request.

From the foregoing, it will be seen that this invention is one well adapted to attain all the ends and objects hereinabove set forth together with other advantages which are inherent to the structure and method. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

Various embodiments of systems, devices, and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations, locations, etc. have been described for use with disclosed embodiments, others besides those disclosed may be utilized without exceeding the scope of the invention.

Persons of ordinary skill in the relevant arts will recognize that the subject matter hereof may comprise fewer features than illustrated in any of the individual embodiments described above. The embodiments described herein are not meant to be an exhaustive presentation of how the various features of the subject matter herein may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. These are only examples of what is specifically intended, and all possible combinations of numerical values between the lowest value and the highest value enumerated, are to be considered to be expressly stated in this disclosure.

As used herein, “a,” “an,” or “the” can mean one or more than one. For example, “an” image can mean a single image or a plurality of images.

The term “and/or” as used in a phrase such as “A and/or B” herein can include both A and B; A or B; A (alone); and B (alone). Likewise, the term “and/or” as used in a phrase such as “A, B, and/or C” can include at least the following embodiments: A, B, and C; A, B, or C; A or C; A or B; B or C; A and C; A and B; B and C; A (alone); B (alone); and C (alone).

As used herein, the term “about” when referring to a measurable value such as an amount, a temporal duration, and the like, can include variations of +/−20%, more preferably +/−10%, even more preferably +/−5% from the specified value, as such variations are appropriate to reproduce the disclosed methods and systems.

From the foregoing, it will be seen that this invention is one well adapted to attain all the ends and objects hereinabove set forth together with other advantages which are inherent to the structure and method. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A navigation device for navigating an animal environment, the navigation device comprising:
a chassis;
one or more drive wheels for propelling the navigation device;
at least one sensor unit for detecting animals and the environment, the at least one sensor unit configured to communicate with a navigation system to generate a set of waypoints to define a planned path for the navigation device; and
a controller for controlling operation of the one or more drive wheels to move the navigation device along the planned path.

2. The navigation device of claim 1 further comprising an animal movement encouragement device, wherein the animal movement encouragement device has at least two or more operating settings, and wherein one of the two or more operating settings is automatically selected based on a relative location of an animal to the navigation device.

3. The navigation device of claim 1 further comprising a battery for powering a motor that drives the one or more drive wheels of the navigation device, wherein the navigation system monitors a charge level of the battery.

4. The navigation device of claim 3, wherein the navigation system is configured to automatically direct the navigation device to a charging station for charging the battery when the navigation system detects that the charge level of the battery falls below a set threshold.

5. The navigation device of claim 1 further comprising a spray nozzle configured to spray a fluid as the navigation device moves along the planned path.

6. The navigation device of claim 5 further comprising a fluid storage tank, wherein the navigation system monitors a level of fluid in the fluid storage tank, wherein the navigation system is configured to automatically direct the navigation device to a fluid refill station for refilling the fluid storage tank when the navigation system detects that the level of fluid in the fluid storage tank falls below a set threshold.

7. The navigation device of claim 5, wherein the navigation system is configured to denote which areas the animal environment have been sprayed by the fluid.

8. The navigation device of claim 1, wherein the navigation system is configured to communicate an alert to a remote operator if an error occurs as the navigation device moves along the planned path.

9. A method of controlling a navigation device for navigating an animal environment, the method comprising:
processing input information from a sensor unit to determine a location of animals and obstacles in the animal environment;
generating a map of the animal environment and the animals located therein;
generating a set of waypoints that define a planned path through the environment; and
controlling movement of at least one drive wheel of the navigation device to direct the navigation device along the planned path.

10. The method of claim 9 further comprising categorizing each animal into one of a plurality of zones based on each animal's relative location to the navigation device and the planned path of the navigation device through the environment

11. The method of claim 10 further comprising further controlling movement of at least one drive wheel of the navigation device based on which zone of the plurality of zones that each animal is categorized into.

12. The method of claim 11 further comprising controlling operation of an animal movement encouragement device of the navigation device based on which zone of the plurality of zones that each animal is categorized into.

13. The method of claim 12, wherein controlling operation of the animal movement encouragement device is further adjusted based on a detected size of each animal.

14. The method of claim 9, wherein the planned path is through a gate, wherein visual indicators on the gate are used to determine a precise pose of the gate relative to the navigation device, wherein a secondary set of waypoints is generated that defines a local path through the gate.

15. The method of claim 9, wherein the navigation device moves from a first waypoint to a second adjacent waypoint to travel along the planned path.

16. A navigation device for navigating an animal environment including a gate, the navigation device comprising:
a chassis;
a drive wheel;
one or more sensor units for detecting animals and the environment, the one or more sensor units configured to communicate with a navigation system to generate a set of waypoints to define a planned global path for the navigation device that passes through an opening in the gate; and
a controller for controlling operation of the drive wheel to move the navigation device along the planned global path;
wherein at least one of the one or more sensor units is configured to detect a fiducial marker positioned on the gate to accurately determine a pose of the gate relative to the navigation device.

17. The navigation device of claim 16, wherein the navigation system uses the pose of the gate relative to the navigation device to generate a secondary set of waypoints that defines a local path through the gate, wherein the controller controls operation of the drive wheel to move the navigation device along the local path through the gate.

18. The navigation device of claim 17, wherein the navigation device moves from a first waypoint in the secondary set of waypoints to a second adjacent waypoint in the secondary set of waypoints to travel along the local path.

19. The navigation device of claim 18, wherein the navigation system is configured to communicate an alert to a remote dispatch system if the navigation device cannot reach the second adjacent waypoint in the secondary set of waypoints.
